(19) United States
(12) Patent Application Publication
(10) Pub. No.: US 2013/0145293 A1
(43) Pub. Date: Jun. 6, 2013

(54) METHODS, APPARATUSES, AND COMPUTER-READABLE MEDIA FOR PROVIDING AVAILABILITY METAPHOR(S) REPRESENTING COMMUNICATIONS AVAILABILITY IN AN INTERACTIVE MAP

(71) Applicants: John H. Yoakum, Cary, NC (US); Philip Edholm, Pleasanton, CA (US)

(72) Inventors: John H. Yoakum, Cary, NC (US); Philip Edholm, Pleasanton, CA (US)

(73) Assignee: Avaya Inc., Basking Ridge, NJ (US)

(21) Appl. No.: 13/308,835

(22) Filed: Dec. 1, 2011

(51) Int. Cl. G06F 3/048

(52) U.S. Cl. 715/764

(57) ABSTRACT

Methods, apparatuses, and computer-readable media for providing at least one availability metaphor representing communications availability of at least one entity in an interactive map are disclosed. In one embodiment, a request to provide a map comprising at least one availability metaphor representing an availability state of an entity for communications may be received. For the at least one availability metaphor, an availability state of the entity associated with the at least one availability metaphor may be determined. A modified instance of the map comprised of the at least one availability metaphor may be generated based on the determined availability state of the entity associated with the at least one availability metaphor. The at least one availability metaphor of the modified instance of the map may represent the availability state of the associated entity. The modified instance of the map may be transmitted for rendering.

### RELATED APPLICATION

This application is related to U.S. patent application Ser. No. ______ filed on Dec. 1, 2011 and entitled “METHODS, APPARATUSES, AND COMPUTER-READABLE MEDIA FOR PROVIDING AT LEAST ONE AVAILABILITY METAPHOR OF AT LEAST ONE REAL WORLD ENTITY IN A VIRTUAL WORLD,” which is hereby incorporated herein by reference in its entirety.

### BACKGROUND

1. Field of the Disclosure

The technology of the disclosure relates to computer implemented interactive maps.

2. Technical Background

Positioning workers remotely from a company office can provide benefits and challenges to a company. Workers may be remotely positioned at customer or client sites, which may provide various advantages. For example, remotely positioned workers may have an increased ability to observe how customers/clients make use of a company's goods and/or services. Remotely positioned workers may also have increased customer/client contact, which may generate additional opportunities for obtaining customer/client work.

Furthermore, remotely positioned workers may also reduce company costs, such as company office heating and air conditioning costs, leased office space costs, parking requirements, and commuting times. Remote workers may also save gasoline costs, vehicle maintenance costs, and commuting times. Remote workers may also be provided work schedule flexibility, which may provide flexibility in coordinating work and family schedules.

However, working on-site at a company office also has its advantages. Working in physical proximity to colleagues may provide increased opportunities for interaction with those colleagues. This interaction may be productive and/or beneficial for the company. Working in physical proximity to colleagues may provide increased opportunities to collaborate with colleagues. Working in physical proximity to colleagues may also provide some insight into the availability of those colleagues for interaction.

Regardless of whether an individual is located remotely from or in physical proximity to one or more other individuals, it may be difficult to know when the one or more other individuals will be receptive to being contacted. Furthermore, one may overestimate or underestimate another individual's willingness to communicate at any given time.

### SUMMARY OF THE DETAILED DESCRIPTION

Embodiments disclosed in the detailed description include methods, apparatuses, and computer-readable media for providing availability metaphor(s) representing communications availability in an interactive map. In one embodiment, a request to provide a map comprising at least one availability metaphor representing an availability state of an entity for communications may be received. For the at least one availability metaphor, an availability state of the entity associated with the at least one availability metaphor may be determined. A modified instance of the map comprised of the at least one availability metaphor may be generated based on the determined availability state of the entity associated with the at least one availability metaphor. The at least one availability metaphor of the modified instance of the map may represent the availability state of the associated entity. The modified instance of the map may be transmitted for rendering. As a non-limiting example, the method may be performed by a map server for providing interactive maps. As a further non-limiting example, the modified instance of the interactive map may be transmitted for rendering to a map user device.

In another embodiment, an apparatus for providing availability metaphor(s) representing communications availability of at least one entity in an interactive map is disclosed. The apparatus comprises a communications interface adapted to interface with a network. The apparatus further comprises a control system coupled to the communications interface. The control system is configured to receive a request to provide a map. The map comprises at least one availability metaphor representing an availability state of an entity for communications. The control system is further configured to determine, for the at least one availability metaphor, the availability state of the entity associated with the at least one availability metaphor. The control system is further configured to generate a modified instance of the map based on the determined at least one availability state of the at least one entity associated with the at least one availability metaphor. The modified instance of the map comprises the at least one availability metaphor. The at least one availability metaphor of the modified instance of the map represents the availability state of the associated entity. The control system is further configured to transmit the modified instance of the interactive map for rendering. As a non-limiting example, the apparatus may be a map server for providing interactive maps. As a further non-limiting example, the modified instance of the interactive map may be transmitted for rendering to a map user device.

In another embodiment, a computer-readable medium is disclosed. The computer-readable medium has stored thereon computer-executable instructions to cause an electronic device to implement a method for providing availability metaphor(s) representing communications availability of at least one entity in an interactive map. The computer-executable instructions include receiving a request to provide a map. The map comprises at least one availability metaphor representing an availability state of an entity for communications. The computer-executable instructions further include determining, for the at least one availability metaphor, the availability state of the entity associated with the at least one availability metaphor. The computer-executable instructions further include generating a modified instance of the map based on the determined at least one availability state of the at least one entity associated with the at least one availability metaphor. The modified instance of the map comprises the at least one availability metaphor. The at least one availability metaphor represents the availability state of the associated entity. The computer-executable instructions further include transmitting the modified instance of the map for rendering. As a non-limiting example, the computer-readable instructions may be computer-readable instructions for a map server for providing interactive maps. As a further non-limiting example, the computer-readable instructions may be used for transmitting the modified instance of the map for rendering to a map user device.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

The accompanying drawing figures incorporated in and forming a part of this specification illustrate several aspects of the disclosure, and together with the description serve to explain the principles of the disclosure.

FIG. 1 depicts a floor layout of an interactive map including availability metaphors representing communications availability of various entities;

FIG. 2 is an exemplary flowchart illustrating an exemplary method for providing availability metaphor(s) representing communications availability of various entities in an interactive map;

FIGS. 3A-3D illustrate zooming in through various views of an interactive map comprising availability metaphors representing availability states of various entities for communications;

FIG. 4 illustrates an embodiment of an exemplary availability rule set (e.g., an interruptibility rule set);

FIG. 5A through 5D illustrate a rendered three-dimensional interactive map comprising availability metaphors;

FIGS. 6A through 6D illustrate zooming in through various view of an interactive map comprising availability metaphors;

FIG. 7A is a block diagram illustrating a system in which embodiments disclosed herein may be practiced;

FIG. 7B is a block diagram illustrating various exemplary entity sensors;

FIG. 8 illustrates an exemplary message flow for determining an availability state (e.g., a presence state) of an entity;

FIG. 9 illustrates an exemplary message flow for determining an availability state (e.g., an interruptibility state) of an entity;

FIGS. 10A through 10D illustrate an exemplary message flow for providing availability metaphor(s) of entities in an interactive map;

FIG. 11 illustrates an embodiment of an exemplary data structure with which embodiments disclosed herein may be practiced;

FIG. 12 is a schematic diagram representation of an exemplary device in the system of FIG. 7A, for implementing a map server, an availability server, a map user device, a calendar server, an entity device and/or an entity sensor, and configured to execute instructions from an exemplary computer-readable medium to perform the functions described herein.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed in the detailed description include methods, apparatuses, and computer-readable media for providing availability metaphor(s) representing communications availability in an interactive map. In one embodiment, a request to provide a map comprising at least one availability metaphor representing an availability state of an entity for communications may be received. For the at least one availability metaphor, an availability state of the entity associated with the at least one availability metaphor may be determined. A modified instance of the map comprised of the at least one availability metaphor may be generated based on the determined availability state of the entity associated with the at least one availability metaphor. The at least one availability metaphor of the modified instance of the map may represent the availability state of the associated entity. The modified instance of the map may be transmitted for rendering. As a non-limiting example, the method may be performed by a map server for providing interactive maps. As a further non-limiting example, the modified instance of the interactive map may be transmitted for rendering to a map user device. This method may allow a viewing user viewing the map to more accurately perceive the availability of one or more entities for communications (as non-limiting examples, by reducing overestimates and/or underestimates of the perceived availability of the one or more entities).

A position of a real world door (e.g., open or closed) may not be a significant indicator of a person's actual availability. The real world door of a real world office may be closed because a hall is noisy or may become noisy. The real world door may be closed to avoid disturbing others on the hall with conversations or other sounds from the office. The real world door may be closed to increase the privacy of conversations in the office. The real world door may be closed to prevent odors from emanating into or from the office. The real world door may be closed to maintain an increased or decreased humidity or temperature in an office. The real world door may be open as a matter of office convention or policy. Accordingly, the real world door may be open or closed for any of a variety of reasons which do not indicate a person's actual availability. However, whether a person's real world door is open or closed may significantly affect a perceived interruptibility that one or more viewers of the real world door will perceive for an occupant of the office.

Whether an office's occupant may be seen through a window of the office may also not be a significant indicator of a person's actual availability. Though a person is present in the office, the person may or may not wish to be disturbed. Furthermore, though a person is not present in the office, the person may or may not be available. As non-limiting examples, the person may be in a nearby room or office, in a meeting, or traveling. When present or away from the office, the person may or may not be remotely contactable (for example, by phone). However, whether a person is or is not viewable through a real world window may significantly affect a perceived availability (e.g., presence and/or interruptibility) that one or more viewers of the real world window will perceive for the occupant of the office.

Accordingly, one or more viewers of a real world door and/or a real world window of a real world office may incorrectly perceive (e.g., underestimate or overestimate) the availability (for example, interruptibility and/or presence) of the real world office's occupant. In this regard, in some instances, a viewer of the real world door and/or the real world window may perceive that a person is available when the person is not available, or more available when the person is less available. In other instances, the viewer may incorrectly perceive that a person is not available when the person is available, or less available when the person is more available.

Furthermore, persons not physically present in an office may not be able to perceive a real world door and/or a real world window of an office.

Furthermore, different viewers of a real world door and/or a real world window of an office may observe a same position of the real world door and/or the real world window, regardless of whether the office's occupant is more or less available (e.g., interruptible) to one of the different viewers than another of the different viewers.

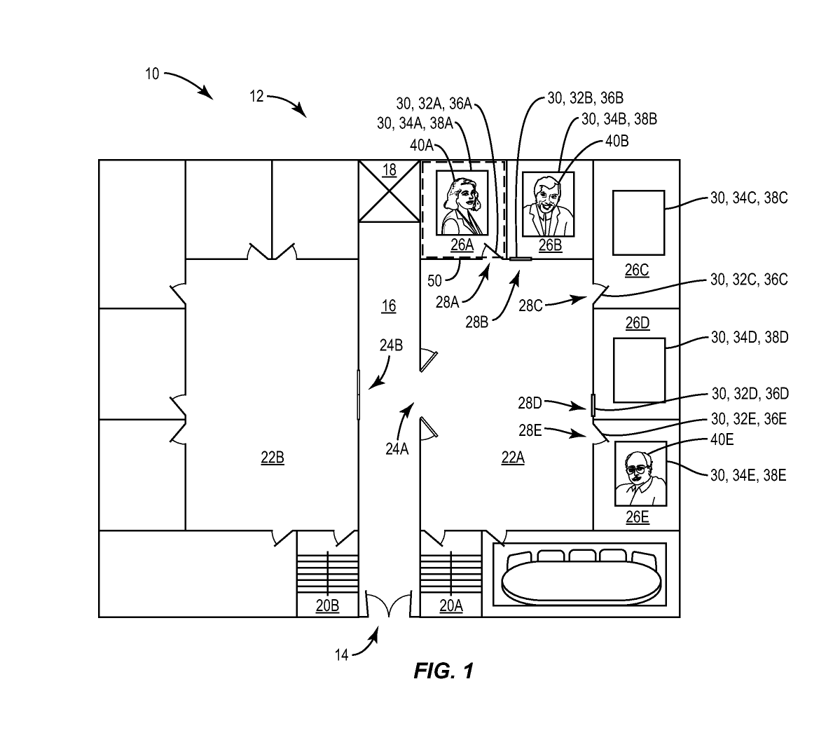

Referring now to FIG. 1, and as herein discussed in further detail, an interactive map comprising availability metaphor(s) representing communications availability of one or more entities may be provided. As depicted in FIG. 1, an interactive map 10 may comprise a floor layout 12 of a building. Floor layout 12 may depict various structures of a floor of a building, including building entrance(s) 14, building hallway(s) 16, elevator(s) 18, stairs 20 (as non-limiting examples, 20A, 20B), building suite(s) 22 (as non-limiting examples, 22A, 22B), building suite entrance(s) 24 (as non-limiting examples, 24A, 24B), room(s) or office(s) 26 (as non-limiting examples 26A, 26B, 26C, 26D, 26E), room or office entrance(s) 28 (as non-limiting examples, 28A, 28B, 28C, 28D, 28E).

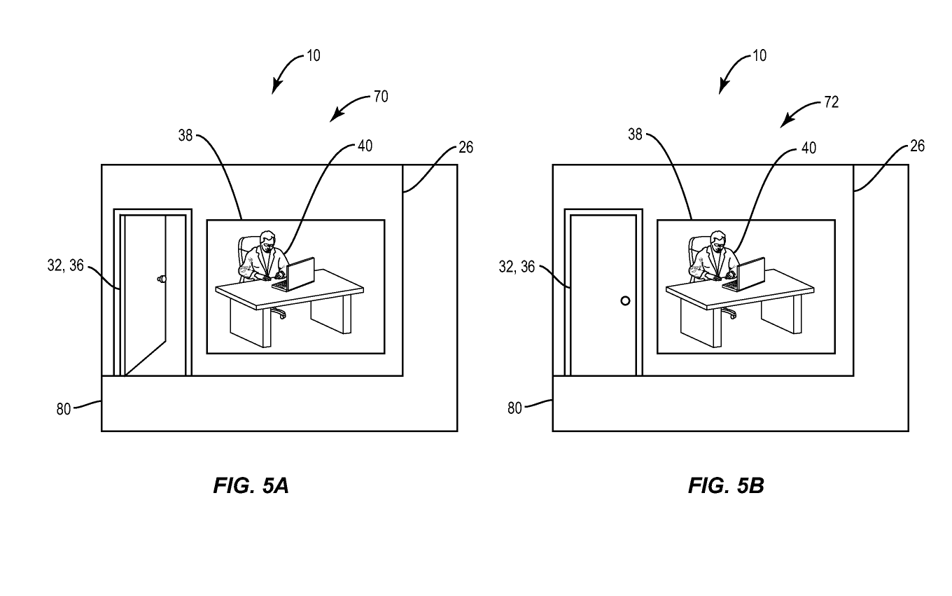

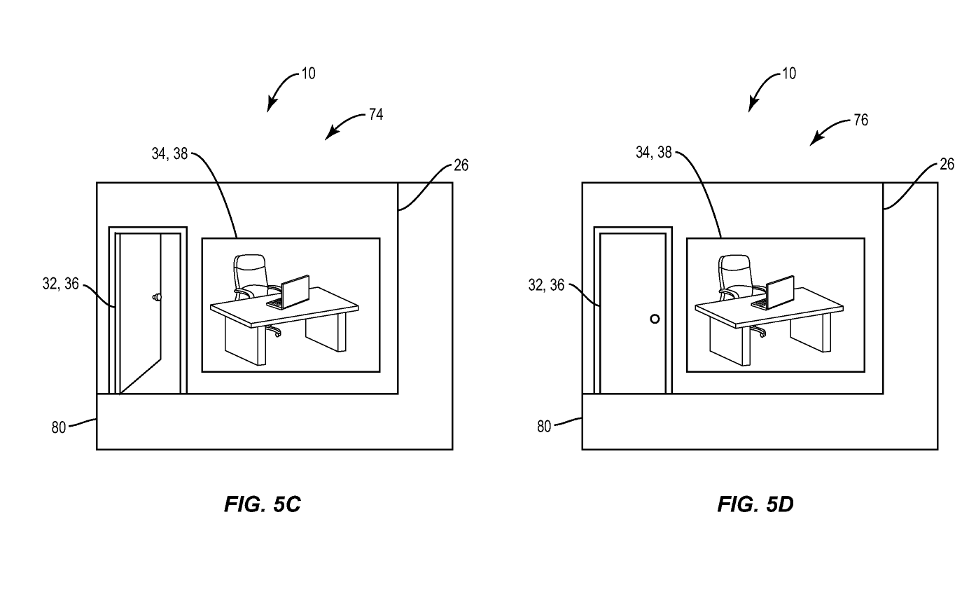

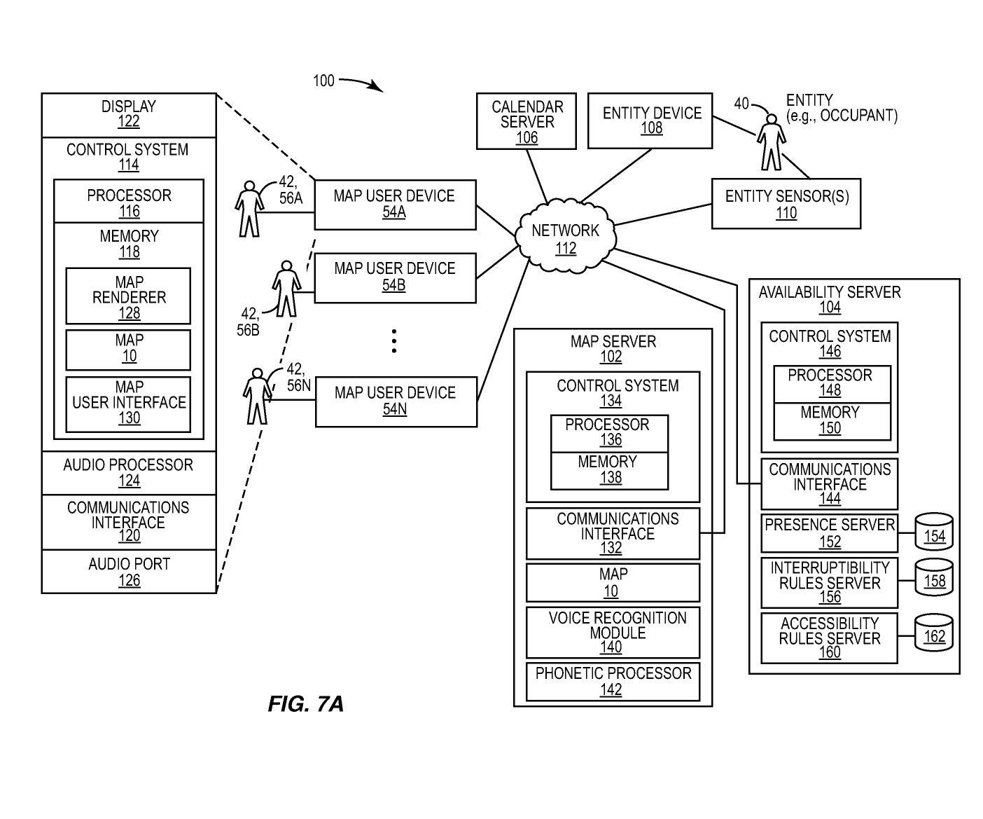

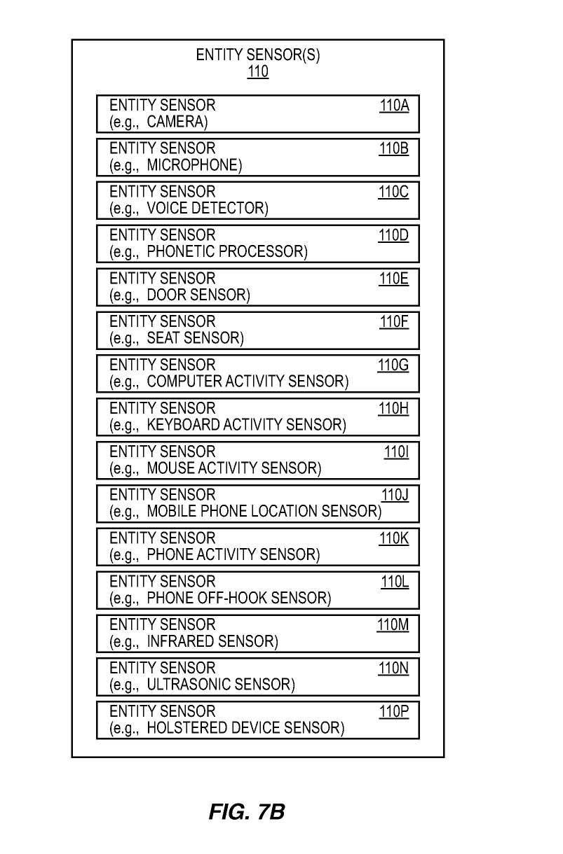

Floor layout 12 may also depict one or more availability metaphors 30 (as non-limiting examples, presence metaphors 34 (34A, 34B, 34C, 34D, 34E) and interruptibility metaphors 32 (32A, 32B, 32C, 32D, 32E)). An availability metaphor 30 comprises one or more objects in an interactive map 10 representing the availability of an entity 40 (FIGS. 5A, 7A) for communications to a map viewer 42 (FIG. 7A) (as non-limiting examples, an interactive map user 56A, 56B, or 56C (FIG. 7A)) of the interactive map 10. (Herein, an interactive map user 56 may also be referred to as a viewing interactive map user 56, a map user 56, or a viewing entity 56). In one embodiment, at least one availability metaphor 30 may comprise an interruptibility metaphor 32. The interruptibility metaphor 32 comprises one or more objects in the interactive map 10 representing the interruptibility of the entity 40 to the map viewer 42 of the interactive map 10. In another embodiment, the at least one availability metaphor 30 may comprise a presence metaphor 34. The presence metaphor 34 comprises one or more objects in the interactive map 10 representing the presence of the entity 40 to the map viewer 42 of the interactive map 10. Availability metaphors 30 (e.g., interruptibility metaphors 32 and/or presence metaphors 34) may represent the availability (e.g., interruptibility and/or presence) of the entity 40 based on one or more availability rules 44 (e.g., interruptibility rules 46 and/or presence rules 48). Providing availability rules 44 controlling the availability state represented by one or more availability metaphors 30 (e.g., interruptibility metaphor(s) 32 and/or presence metaphor(s) 35) on the interactive map 10 may provide a greater accuracy for communicating availability (for example, interruptibility and/or presence) information to the map viewer 42 of the one or more availability metaphors 30.

Presence is an indication of whether an entity 40 is physically present at a certain location, whether the entity 40 is physically present within a defined area, whether the entity 40 is logged into a certain device, and/or whether the entity 40 is actively using a certain device. Presence may be used as a proxy for determining whether there exists a capability (for example, any capability) to communicate with the entity 40. However, determining merely whether there is a capability of communicating with the entity 40 does not indicate whether the entity 40 would be receptive to such communication.

Interruptibility is an indication of whether an entity 40 authorizes an interruption of a current task of the entity 40. The entity 40 is interruptible by a map viewer 42 if the entity 40 would permit an interruption of the current task of the entity 40 by the map viewer 42. The entity 40 is not interruptible by the map viewer 42 if the entity 40 would not permit an interruption of the current task of the entity 40 by the map viewer 42. Interruptibility may be viewer-specific. In this regard, during a certain time interval, the entity 40 may be interruptible to some map viewers 42 and not interruptible to other map viewers 42.

An entity 40 may be an occupant of a parcel 50 depicted in the interactive map 10. As non-limiting examples, the entity 40 may be a person, group, organization, or company. A parcel 50 is a defined area. A parcel 50 may comprise a portion of a room 26, one or more rooms 26, a portion of a suite 22, one or more suites 22, a portion of a building floor, one or more building floors, a portion of a building, one or more buildings, a portion of real property, and/or one or more pieces of real property. In one embodiment, a parcel 50 may comprise a room or office 26, as non-limiting examples 26A, 26B, 26C, 26D, or 26E.

An occupant of a parcel 50 is an entity 40 (as non-limiting examples, a person, group, company, or organization) to whom the parcel 50 has been assigned, as non-limiting examples, through ownership, tenancy, or other assignment. For example, a company employee may be assigned a parcel (as non-limiting examples, one or more rooms, offices, and/or cubicles) of a building. As non-limiting examples, an occupant may be a person, group, company, or organization that occupies or has quarters or space in or on something. One or more occupants may occupy a parcel 50.

FIG. 1 depicts a floor layout 12 comprising several availability metaphors 30. Some of the availability metaphors 30 depicted in FIG. 1 are interruptibility metaphors 32 (32A, 32B, 32C, 32D, 32E). Other of the availability metaphors 30 depicted in FIG. 1 are presence metaphors 34 (34A, 34B, 34C, 34D, 34E). In FIG. 1, interruptibility metaphors 32 (as non-limiting examples 32A, 32B, 32C, 32D, 32E) are depicted as virtual door(s) 36 (as non-limiting examples, 36A, 36B, 36C, 36D, 36E), and presence metaphors 34 (as non-limiting examples, 34A, 34B, 34C, 34D, 34E) are depicted as virtual windows 38 (38A, 38B, 38C, 38D, 38E). These availability metaphors 30 may be displayed upon or integral to the interactive map 10 to represent the availability (as non-limiting examples, presence and/or interruptibility) of an entity 40 to a map viewer 42 of the interactive map 10.

A virtual door 36 may be an interruptibility metaphor 32 for an entity 40. If entity 40 is not interruptible, virtual door 36 may be provided within an interactive map 10 as a closed door. If entity 40 is interruptible, virtual door 36 may be provided within interactive map 10 as an open door. Other interruptibility states of entity 40 are also representable by virtual door 36. As one non-limiting example, a virtual door 36 which is slightly open may represent that entity 40 is interruptible for high priority matters but not interruptible for low priority matters.

Other characteristics of virtual door 36 may also be used to provide an availability metaphor 30 (as non-limiting examples, an interruptibility metaphor 32 and/or a presence metaphor 34) for entity 40. As non-limiting examples, other such characteristics of virtual door 36 may include: a color of the virtual door 36 among a plurality of colors, a darker or lighter color of the virtual door 36, an increased or decreased transparency of the virtual door 36, an absence or presence of the virtual door 36, a greater or lesser size of the virtual door 36, a greater or lesser thickness of the virtual door 36, an open position or closed position of a window through the virtual door 36, and/or a texture of the virtual door 36 (as non-limiting examples, a stone texture, a wooden texture, or a gel texture).

In this regard in one embodiment, a color of virtual door 36 may be any of a plurality of colors (as a non-limiting example, an ordered rainbow of colors). A first color (e.g., red) may indicate no interruptibility. A second color (e.g., violet) may indicate interruptibility. Intermediate colors (e.g., orange, yellow, green, blue, indigo) may indicate intermediate levels of interruptibility, with colors closer to the first color (e.g., red) among the plurality of colors representing less interruptibility and with colors closer to the second color (e.g., violet) among the plurality of colors representing greater interruptibility. Alternative color palette orderings could also be used.

In another embodiment, virtual door 36 may have any color intensity among a plurality of color intensities. A darkest color intensity of the virtual door 36 among the plurality of color intensities may indicate no interruptibility. A lightest color intensity of the virtual door 36 among the plurality of color intensities may indicate interruptibility. Intermediate color intensities of the virtual door 36 may indicate intermediate levels of interruptibility.

In another embodiment, virtual door 36 may have an increased or decreased transparency. An opaqueness (e.g., a least transparency among a plurality of transparencies) of the virtual door 36 may indicate no interruptibility, whereas a greatest transparency among a plurality of transparencies of the virtual door 36 may indicate interruptibility. Intermediate transparencies of virtual door 36 may indicate intermediate levels of interruptibility.

In another embodiment, an absence or presence of the virtual door 36 may indicate interruptibility. In this regard, as a non-limiting example, a present virtual door 36 (as a non-limiting example, a displayed virtual door 36) may indicate no interruptibility, whereas an absent virtual door 36 (as a non-limiting example, a lack of a display of virtual door 36) may indicate interruptibility.

In another embodiment, a greater or lesser size of the virtual door 36 may indicate interruptibility. In this regard, as a non-limiting example, a smallest door size among a plurality of door sizes for virtual door 36 may indicate no interruptibility, whereas a greatest door size among a plurality of door sizes for virtual door 36 may indicate interruptibility. Intermediate door sizes of virtual door 36 may indicate intermediate levels of interruptibility.

In another embodiment, a greater or lesser thickness of a virtual door 36 may represent interruptibility. In this regard, as a non-limiting example, a greatest thickness among a plurality of thicknesses of the virtual door 36 may represent no interruptibility, whereas a least thickness among a plurality of thicknesses of the virtual door 36 may represent interruptibility. Intermediate thicknesses of virtual door 36 may represent intermediate levels of interruptibility.

In another embodiment, virtual door 36 may comprise a window through at least a portion of the virtual door 36, the window through the virtual door 36 representing interruptibility. A closed window of the virtual door 36 may indicate no interruptibility, whereas a completely open window of the virtual door 36 may indicate interruptibility. Intermediate positions of the window of the virtual door 36 may represent intermediate levels of interruptibility.

In another embodiment, virtual door 36 may have a texture representing interruptibility. In this regard, as a non-limiting example, a stone texture of virtual door 36 may indicate no interruptibility, whereas a gel texture of the virtual door 36 may indicate interruptibility. Intermediate textures (e.g., brick, wooden, plastic, foam) of virtual door 36 could represent intermediate levels of interruptibility.

An advantage of using a virtual door 36 to indicate an interruptibility state of an entity 40 is that the virtual door 36 provides an intuitive metaphor for communicating the interruptibility state of the entity 40. Providing interactive map rules controlling the interruptibility state represented by virtual door 36 may provide a greater accuracy for communicating interruptibility information than a real world door. Though a real world door being closed may have no significant relationship with a person's actual interruptibility, a real world door being closed may have a significant effect on the perceived interruptibility that viewers of the real world door will perceive for the entity 40. Embodiments in accordance with this disclosure may allow an entity 40 to provide an interruptibility rule set (as a non-limiting example, interruptibility rules 46) consistent or more consistent with the actual availability of the entity 40. As such, embodiments in accordance with this disclosure may allow a map viewer 42 of the virtual door 36 to perceive interruptibility of the entity 40 associated with the virtual door 36 with an increased correlation and/or accuracy to the actual interruptibility of the entity 40 associated with the virtual door 36.

Any of the herein discussed embodiments may be used alone or in any combination as an availability metaphor 30 to represent the availability and/or interruptibility of an entity 40.

The at least one availability metaphor 30 of an interactive map 10 may comprise a virtual window 38 representing a presence of entity 40 in the real world. In this regard, referring again to FIG. 1, virtual window 38 may be a presence metaphor 34 for entity 40. In other words, at least one characteristic of virtual window 38 may represent a presence of entity 40 in the real world.

In one embodiment, if entity 40 is present (as a non-limiting example, present within at least one defined area of the real world as detected by one or more entity sensors 110 depicted in FIG. 7B), then a virtual window 38 may be provided within an interactive map 10 as a transparent window. Alternatively, if entity 40 is present, then the virtual window 38 may be provided within the interactive map 10 as an open window.

If entity 40 is not present (as a non-limiting example, not present within at least one defined area of the real world as detected by one or more entity sensors 110) then virtual window 38 may be provided within an interactive map 10 as a nontransparent window. Alternatively, if entity 40 is not present, then virtual window 38 may be provided within the interactive map 10 as a closed window.

In a further embodiment, at least one image of entity 40 may be provided in the interactive map 10 as viewable through the virtual window 38 if entity 40 is present. In this embodiment, the at least one image of the entity 40 is not provided in the interactive map 10 as viewable through the virtual window 38 if entity 40 is not present.

Other characteristics of the virtual window 38 may also be used to represent the availability of entity 40. As non-limiting examples, other such characteristics of virtual window 38 that may be used to represent the presence of entity 40 include: a color of the virtual window 38 among a plurality of colors, a darker or lighter color of the virtual window 38, an increased or decreased transparency of the virtual window 38, an absence or presence of the virtual window 38, a greater or lesser size of the virtual window 38, a greater or lesser thickness of the virtual window 38, an open position or closed position of the virtual window 38, and/or a texture of the virtual window 38 (e.g., a stone texture, a wooden texture, or a gel texture).

A first such characteristic among any of the herein discussed characteristics may represent the presence of entity 40. A second such characteristic among any of the herein discussed characteristics may represent that entity 40 is not present. Intermediate characteristics between the first and second characteristics may represent intermediate levels of the presence of entity 40. In this regard, as a non-limiting example, a first intermediate represented level of presence may represent that the entity 40 is present on a device and reachable via text messaging, but not reachable for audio or video communication. By way of a further non-limiting example, a second intermediate represented level of presence (e.g. having a greater represented level of presence than the first level of presence) may represent that the entity 40 is present on the device or at a location with audio communications capability, but without video communications capability.

An individual availability metaphor 30 in a virtual world may represent both presence and interruptibility of a certain entity 40. As a non-limiting example, an individual availability metaphor 30 may be comprised of a virtual window 38 having a virtual window shade. The virtual window shade may be raised so as to not conceal any or most portions of a virtual window 38 from an interactive map user 56 viewing interactive map 10. The virtual window shade may also be lowered so as to conceal all or most portions of the virtual window 38. In one embodiment, a raised virtual window shade represents that entity 40 is interruptible for communications with a viewing interactive map user 56, whereas a lowered virtual window shade represents that entity 40 is not interruptible for communications with viewing interactive map user 56. In this embodiment, at least one image of entity 40 may be provided as viewable in the virtual window 38 if entity 40 is present, whereas the at least one image of the entity 40 is not provided as viewable through the virtual window 38 if entity 40 is not present.

FIG. 1 provides an exemplary embodiment depicting several availability metaphors 30. In FIG. 1, virtual windows 38 (e.g., 38A, 38B, 38C, 38D, 38E) are availability metaphors 30, and more specifically presence metaphors 34 (e.g., 34A, 34B, 34C, 34D, 34E). Presence metaphors 34 (e.g., 34A, 34B, 34C, 34D, 34D) each represent the presence of an entity 40 occupying an office 26 (e.g., 26A, 26B, 26C, 26D, 26E). In this embodiment, a display of at least one image of entity 40 in or through virtual windows 38 represents that entity 40 is present in the depicted office of the entity 40. As a non-limiting example, the display of the at least one image of entity 40 may be an image periodically captured from a camera in the real world office of the entity 40.

In FIG. 1, virtual doors 36 (e.g., 36A, 36B, 36C, 36D, 36E) are availability metaphors 30, and more specifically interruptibility metaphors 32 (32A, 32B, 32C, 32D, 32E). Interruptibility metaphors 32 (e.g., 32A, 32B, 32C, 32D, 32E) each represent the interruptibility of an entity 40 occupying an office 26 (e.g., 26A, 26B, 26C, 26D, 26E). In this embodiment, an open state of virtual door 36 represents that entity 40 is interruptible. Also in this embodiment, a closed state of virtual door 36 represents that entity 40 is not interruptible.

In this regard, virtual window 38A represents that an entity 40 (e.g., an entity 40A) occupying office 26A is present. In one embodiment, virtual window 38A displays at least one image of the entity 40A occupying office 26A if the entity 40A is present in the office 26A. In another embodiment, displaying at least one image of the entity 40A occupying office 26A in virtual window 28A may represent that there exists a capability to communicate with entity 40A. In this embodiment, virtual window 28A may display entity 40A occupying office 26A whether or not the entity 40A is present in the real world office depicted by office 26A. Entity 40A may be away from office 26A but physically present within a known area, logged into a known device, or actively using a known device. In any of these cases, the display of an image of the entity 40A in virtual window 28A represents that there exists a capability to communicate with entity 40A, regardless of whether the entity 40A is actually present in office 26A.

Virtual door 36A is an interruptibility metaphor 32A representing that the entity 40A occupying office 26A is interruptible. A viewing interactive map user 56 (FIG. 7A) viewing the interactive map 10 may provide a gesture (as a non-limiting example, tapping the office 26A (or tapping virtual window 38A) of the entity 40 with whom the viewing interactive map user 56 would like to communicate) on the interactive map 10 to initiate communications with the entity 40A occupying office 26A. In one embodiment, in response to receiving the gesture, viewing interactive map user 56 may be permitted to initiate communications with entity 40A because the interruptibility metaphor 32A represents that entity 40A is interruptible.

Virtual window 38B is a presence metaphor 34B representing that the entity 40 (e.g., an entity 40B) occupying office 26B is present. Virtual door 36B is an interruptibility metaphor 32B representing that entity 40B is not interruptible. In one embodiment, interactive map user 56 may be denied permission to initiate communications with entity 40B for as long as interruptibility metaphor 32B represents that entity 40B is not interruptible.

Virtual window 38C is a presence metaphor 34C representing that an entity 40 (e.g., an entity 40C (not shown)) occupying office 26C is not present. Though entity 40C is not present in the office 26C, interruptibility metaphor 32C (virtual door 36C) represents that entity 40C is interruptible. Accordingly, a viewing interactive map user 56 may provide a gesture (as a non-limiting example, tapping the office 26C or virtual window 38C on the interactive map 10) to initiate communications with entity 40C.

Virtual window 38D is a presence metaphor 34D representing that an entity 40 (e.g., an entity 40D (not shown)) occupying office 26D is not present. Interruptibility metaphor 32D (virtual door 36D) represents that entity 40D is also not interruptible. Accordingly, in one embodiment, an interactive map user 56 may be denied permission to initiate communications with entity 40D for as long as interruptibility metaphor 32D represents that entity 40D is not interruptible.

Virtual window 38E is a presence metaphor 34E representing that an entity 40 (e.g., an entity 40E) occupying office 26E is present. Virtual door 36E is an interruptibility metaphor 32E representing that entity 40E is interruptible.

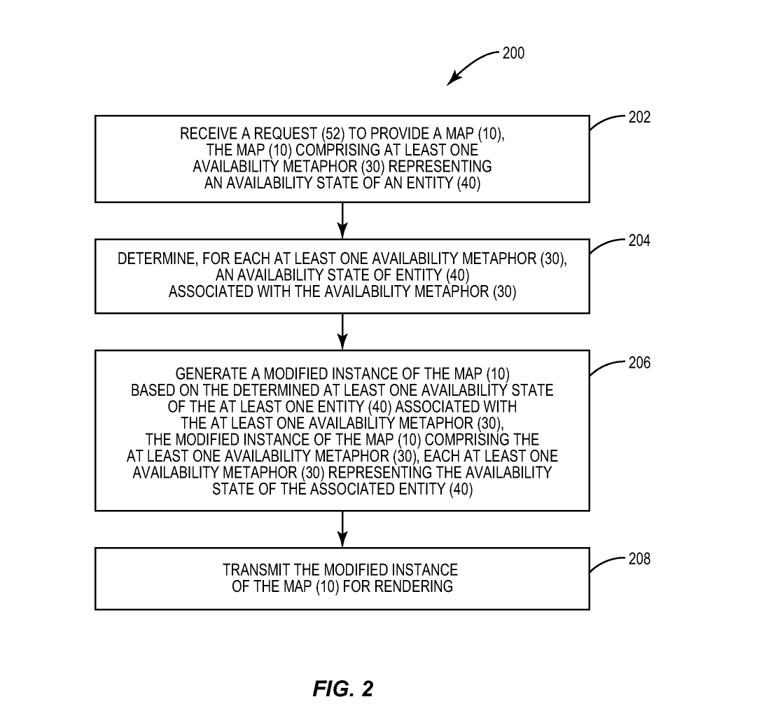

FIG. 2 depicts an exemplary method 200 for providing at least one availability metaphor 30 of at least one entity 40 in an interactive map 10. Method 200 comprises receiving a request 52 to provide an interactive map 10, the interactive map 10 comprising at least one availability metaphor 30 representing at least one availability state of at least one entity 40 (block 202). Method 200 further comprises determining, for each at least one availability metaphor 30, an availability state of an entity 40 associated with the availability metaphor 30 (block 204). Method 200 further comprises generating a modified instance of the interactive map 10 based on the determined at least one availability state of the at least one entity 40 associated with the at least one availability metaphor 30, the modified instance of the interactive map 10 comprising the at least one availability metaphor 30, each at least one availability metaphor 30 representing the availability state of the associated entity 40 (block 206). Method 200 further comprises transmitting the modified instance of the interactive map 10 for rendering (block 208).

Method 200 may comprise additional steps. As a non-limiting example, method 200 may further comprise rendering for display the modified instance of interactive map 10. As another non-limiting example, method 200 may further comprise displaying the rendered modified instance of interactive map 10.

Method 200 may further comprise receiving a map gesture for initiating communications between the entity 40 and a viewing entity (e.g., a map viewer 42 and/or viewing interactive map user 56) viewing the interactive map 10. Method 200 may also comprise initiating communications among the entity 40 and the viewing entity based on the received map gesture. The at least one availability metaphor 30 of the entity 40 may comprise at least one availability metaphor 30 of a person. The entity 40 may comprise an occupant of a defined area. The interactive map 10 may comprise at least one parcel 50 representing the defined area. The defined area may be at least one from the group consisting of: a volume, an enclosed space, a vehicle, a room, an office, an office suite, a conference room, a lobby of a building, and a building. Interactive map 10 may comprise at least one of a two-dimensional map and a three-dimensional map.

Method 200 may further comprise determining the availability state of the entity comprises at least one of: determining a presence of the entity in a defined area, and determining a presence of the entity on a device. Determining the availability state of entity 40 may comprise transmitting a request for availability information for entity 40 to an availability server 104. Determining the availability state of entity 40 may further comprise receiving the availability information for entity 40 from availability server 104. The availability information may comprise availability rules for determining the availability state of entity 40. The availability information may comprise may comprise the availability state of entity 40.

Method 200 may further comprise receiving an identity of a viewing entity (e.g., a map viewer 42 and/or viewing interactive map user 56) for whom the interactive map 10 is to be rendered. Method 200 may further comprise determining the availability of entity 40 based on the identity of the viewing entity.

An availability state of an entity 40 may comprise an availability state of the entity 40 for communications with a viewing entity (as non-limiting examples, interactive map user 54A, 54B, or 54C) viewing the rendered interactive map 10. As a non-limiting example, an availability metaphor 30 (as a non-limiting example, virtual door 36) transmitted to map user device 54A (FIG. 7A) associated with an interactive map user 56A may represent an availability of entity 40 for communication with interactive map user 56A (FIG. 7A). In this manner, the state of the availability metaphor 30 (as a non-limiting example, virtual door 36) may be based, in part, upon the map viewer 42 (as a non-limiting example, an interactive map user 56) viewing the availability metaphor 30. In this regard, availability rules 44 may condition which availability state is provided for display in an availability metaphor 30 based upon who is viewing the availability metaphor 30.

In this regard, method 200 may further comprise receiving an identity of a viewing entity (as a non-limiting example, interactive map user 56A) for whom the interactive map 10 is to be rendered. Method 200 may also further comprise determining the availability of the entity 40 based on the identity of the viewing entity (as a non-limiting example, interactive map user 56A). In addition, different map viewers 42 (e.g., different interactive map users 56) may be concurrently provided interactive maps 10A, 10B presenting different availability states for a same availability metaphor 30 (as non-limiting examples, a same virtual door 36 or a same virtual window 38). As used herein, the term “concurrently” is defined as “at least partially overlapping in time.” In other words, different map viewers 42 (e.g., different interactive map user(s) 56) may be presented, during a same time interval, different availability states for a same availability metaphor 30 (as non-limiting examples, a same virtual door 36 or a same virtual window 38).

In this regard, method 200 may further comprise receiving a second request 58 to provide interactive map 10 for a second viewing entity (as a non-limiting example, interactive map user 56B). Method 200 may further comprise determining a second availability state of entity 40 based on the identity of the second viewing entity (interactive map user 56B). Method 200 may further comprise generating a second modified instance of the interactive map 10 based on the second availability state. Method 200 may further comprise transmitting the second modified instance of the interactive map 10 for rendering for the second viewing entity (interactive map user 56B). In this regard, the modified instance of the interactive map 10 and the second modified instance of the interactive map 10 are for concurrent rendering. Further, the modified instance of the interactive map 10 may provide the entity 40 as available and the second modified instance of the interactive map 10 may provide the entity 40 as not available.

Determining an availability state of an entity 40 may comprise determining a presence of the entity 40 in a defined area in the real world. Alternatively, determining the availability state of the entity 40 may comprise determining a presence of the entity 40 on a device in the real world.

Determining an availability state of the entity 40 may comprise determining an interruptibility of the entity 40. Determining the interruptibility of the entity 40 may comprise determining the interruptibility of the entity 40 based on at least one interruptibility rule.

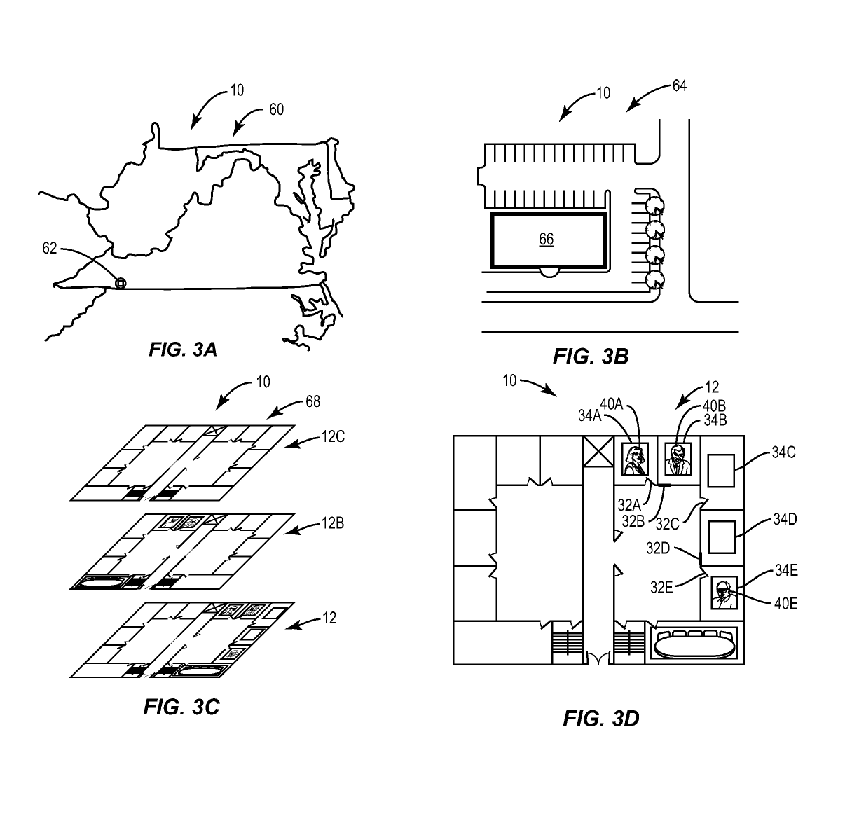

FIGS. 3A through 3D illustrate zooming in through various views of an interactive map 10 comprising availability metaphors 30 representing availability states of entities 40 for communications. FIG. 3A depicts an exemplary regional view 60 of the interactive map 10. An interactive map user 56 may provide a gesture to zoom into a zoom area 62 of the interactive map 10.

FIG. 3B depicts an exemplary aerial view 64 of interactive map 10 which is exterior to a building 66. Aerial view 64 of the interactive map 10 may be viewed after zooming into (or successively zooming into) zoom area 62 of the interactive map 10. A gesture from interactive map user 56 may be received to request floor layouts of the building 66. The received gesture may comprise swiping at least one finger diagonally across the building 66 depicted in the interactive map 10. In a further embodiment, the received gesture may comprise swiping at least one finger diagonally across building 66 from a bottom corner of building 66 towards a top corner of building 66. The corners may be diagonally opposite corners of the building 66. The received gesture may comprise swiping one, two, three, or four fingers diagonally across building 66.

FIG. 3C depicts an exemplary multi-story floor layout view 68 of building 66 of interactive map 10. Multi-story floor layout view 68 may be displayed in response to receiving the above discussed gesture. Multi-story floor layout view 68 may be comprised of one or more floor layout views 12, 12B, 12C of building 66. Each floor layout view 12, 12B, 12C may comprise availability metaphors 30 (as non-limiting examples, presence metaphors 34 and/or interruptibility metaphors 32) for occupants of the building floors and/or offices 26 of building 66. A second gesture from interactive map user 56 may be received to zoom on a particular floor layout among the one or more floor layout views 12, 12B, 12C. The second received gesture may comprise (vertically) swiping at least one finger from a top portion of a floor layout 12 towards a bottom portion of the floor layout 12.

FIG. 3D depicts the exemplary floor layout 12 previously discussed in FIG. 1. Floor layout view 12 may be displayed in response to receiving the above discussed second gesture on the bottom most floor layout 12 displayed in FIG. 3C. Floor layout views corresponding to floor layouts 12B and/or 12C could have been alternatively displayed if the second gesture had been provided for those floor layouts (12B and/or 12C).

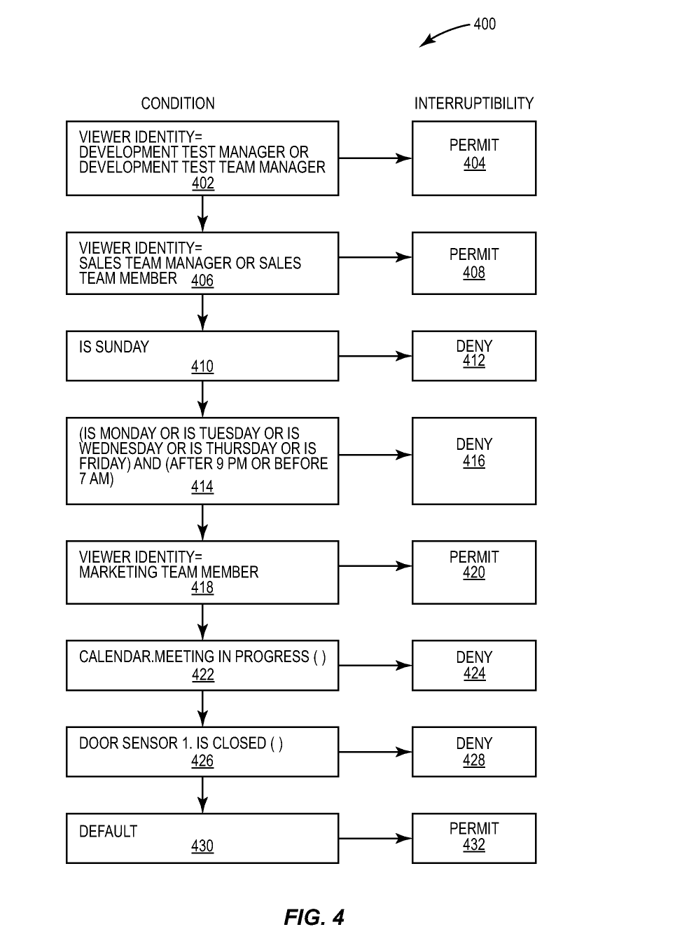

Referring now to FIG. 4, determining an availability state of an entity 40 in the real world may comprise determining an availability state of the entity 40 based on availability rules for the entity 40. The availability rules may comprise interruptibility rules. In this regard, FIG. 4 illustrates an exemplary interruptibility rule set 400 for an entity 40. Each rule of the exemplary interruptibility rule set 400 may be comprised of a condition and a corresponding interruptibility action. Conditions 402, 406, 410, 414, 418, 422, 426, and 430 are provided as non-limiting exemplary conditions. Interruptibility actions 404, 408, 412, 416, 420, 424, 428, and 432 are provided as non-limiting exemplary interruptibility actions. Evaluation of the interruptibility rule set 400 may begin at a first condition 402. If an evaluated condition (e.g., condition 402) is satisfied, then the corresponding interruptibility action (e.g., action 404) occurs. If an evaluated condition is not satisfied, then evaluation continues to a next condition (e.g., condition 406). Evaluation of the conditions of the interruptibility rule set 400 continues until a condition (e.g., condition 402, 406, 410, 414, 418, 422, and 426) is satisfied or alternatively until a default condition (e.g., condition 430) is reached. Upon reaching a default condition (e.g., condition 430), the corresponding interruptibility action (e.g., action 432) occurs.

Evaluation of the exemplary interruptibility rule set 400 may proceed as follows. If an identity of a map viewer 42 (e.g., an interactive map user 56) is a development test manager or development test team member (condition 402), then interruptibility is permitted (404). Otherwise, if an identity of the map viewer 42 (e.g., an interactive map user 56) is a sales team manager or sales team member (406), then interruptibility is permitted (408). Otherwise, if the current day is a Sunday (410), interruptibility is denied (412). Otherwise, if the current day is a Monday, Tuesday, Wednesday, Thursday, or Friday, and the current time is after 9 pm or before 7 am (414), then interruptibility is denied (416). Otherwise, if an identity of the map viewer 42 (e.g., an interactive map user 56) is a marketing team member (418), then interruptibility is permitted (420). Otherwise, if a calendar of entity 40 indicates that a meeting is in progress (422), then interruptibility is denied (424). Otherwise, if a first door sensor associated with the entity 40 is closed (e.g., an office door of the entity 40) (426), then interruptibility is denied (428). Otherwise, the default condition applies (430), and interruptibility is permitted (432). The above provided conditions and interruptibility actions are exemplary. One of skill in the art will appreciate other conditions and/or interruptibility actions that may be used in accordance with this disclosure.

Similar rules sets could be provided for determining availability and/or presence of an entity 40 in accordance with this disclosure. In such cases the interruptibility action would instead be an availability action and/or presence action.

In a further embodiment, an additional condition 429 (not shown) may be provided (as a non-limiting example, after condition 426 and before default condition 430) to detect whether an audible/vibration alerting switch of a mobile phone of entity 40 is set for an audible alert of entity 40 upon receiving an incoming call, or alternatively set for a vibration alert of entity 40 upon receiving an incoming call. If the audible/vibration alerting switch of the mobile phone of entity 40 is set for a vibration alert, then interruptibility is denied, whereas if the audible/vibration switch of the mobile phone of entity 40 is set for an audible alert, then interruptibility is permitted.

Interactive map 10 may also be provided as a three-dimensional map. In this regard, FIGS. 5A through 5D depict rendered views 70, 72, 74, and 76 of a three-dimensional interactive map 10 (FIG. 3). In one embodiment, these views may comprise three-dimensional views (as a non-limiting example, three-dimensional perspective views) of the interior of a building 66. In FIGS. 5A through 5D, interactive map 10 is comprised of a virtual office 26, a virtual hallway 80, a virtual door 36, and a virtual window 38. Virtual office 26 represents a real world office occupied by an entity 40.

The rendered interactive map 10 depicted in views 70, 72, 74, and 76 of FIGS. 5A through 5D is comprised of at least one availability metaphor 30 of an entity 40. In this regard, as depicted in FIGS. 5A through 5D, interactive map 10 may comprise a virtual door 36 (configured as an interruptibility metaphor 32) representing the interruptibility of the entity 40. As also depicted in FIGS. 5A through 5D, interactive map 10 may also comprise a virtual window 38 (configured as a presence metaphor 34) representing a presence of the entity 40.

FIGS. 5A through 5D provide an exemplary embodiment in which a virtual door 36 is an availability metaphor 30 representing an interruptibility of an entity 40 and a virtual window 38 is an availability metaphor 30 representing a presence of entity 40. In this embodiment, an open state of the virtual door 36 represents that entity 40 is interruptible. Also in this embodiment, a closed state of the virtual door 36 represents that entity 40 is not interruptible. In this embodiment, a display of at least one image of entity 40 in the real world in or through the virtual window 38 represents that entity 40 is present in an office of the entity 40. As a non-limiting example, the display of the at least one image of entity 40 may be an image periodically captured from a camera 110A (FIG. 7B) in the real world office of the entity 40.

In accordance with these embodiments, FIG. 5A depicts a presence metaphor 34 (virtual window 38) representing that an entity 40 is present in an office 26 of the entity 40. FIG. 5A also depicts an interruptibility metaphor 32 (virtual door 36) representing that entity 40 is interruptible. Accordingly, an interactive map user 56 may enter virtual office 26 to initiate communications with entity 40.

FIG. 5B depicts a presence metaphor 34 (virtual window 38) representing that an entity 40 is present in an office 26 of the entity 40. Though entity 40 is present in office 26, FIG. 5B also depicts an interruptibility metaphor 32 (virtual door 36) representing that entity 40 is not interruptible. Accordingly, viewing interactive map user 56 may determine to not initiate communications with entity 40.

In one embodiment, viewing interactive map user 56 may be denied an attempt to initiate communications with entity 40 if interruptibility metaphor 32 represents that entity 40 is not interruptible.

In a further embodiment, viewing map user 56 may be allowed to initiate communications with entity 40 even if interruptibility metaphor 32 represents that entity 40 is not interruptible. Allowing viewing map user 56 to contact entity 40 even when interruptibility metaphor 32 represents that entity 40 is not interruptible may be beneficial in cases of urgency and/or emergency.

Interactive map 10 may provide any of various mechanisms for allowing viewing interactive map user 56 to attempt to initiate communications with entity 40. In one embodiment, viewing interactive map user 56 may attempt to initiate communications with entity 40 by gesturing on (as a non-limiting example, double-tapping on) an availability metaphor 30 (as non-limiting examples, an interruptibility metaphor 32 and/or a presence metaphor 34) for entity 40. As a non-limiting example, viewing interactive map user 56 may attempt to initiate communications with entity 40 by single-tapping and/or double-tapping on a virtual door 36 and/or a virtual window 38 associated with entity 40 in the interactive map 10. In a further embodiment, viewing interactive map user 56 may attempt to initiate communications with entity 40 by gesturing on (as a non-limiting example, single-tapping and/or double-tapping on) a virtual phone in the virtual office 26 occupied by entity 40. One of skill in the art will appreciate other mechanisms that viewing interactive map user 56 may use to attempt to initiate communications with entity 40 in accordance with this disclosure.

In a further embodiment, viewing interactive map user 56 may attempt to initiate communications with entity 40 by zooming into or entering a virtual office 26 (as a non-limiting example, an interactive view of the virtual office 26) occupied by entity 40. In one embodiment, when an availability metaphor 30 (as non-limiting examples, an interruptibility metaphor 32 and/or a presence metaphor 34) represents that entity 40 is not available for communications with viewing interactive map user 56, viewing interactive map user 56 may be denied entrance to (and/or denied an ability to zoom into) virtual office 26 by the interactive map 10. In this manner, interactive map 10 may prevent a communications attempt by interactive map user 56 with entity 40.

FIG. 5C depicts a presence metaphor 34 (virtual window 38) representing that an entity 40 is not present in the office 26 of the entity 40. Though not present in the office 26, FIG. 5C also depicts an interruptibility metaphor 32 (virtual door 36) representing that entity 40 is interruptible. Accordingly, viewing interactive map user 56 may initiate communications with entity 40.

FIG. 5D depicts a presence metaphor 34 (virtual window 38) representing that an entity 40 is not present in the office 26 of the entity 40. FIG. 5D also depicts an interruptibility metaphor 32 (virtual door 36) representing that entity 40 is not interruptible. Accordingly, viewing interactive map user 56 may determine to not zoom into and/or enter virtual office 26 to attempt to initiate communications with entity 40. In one embodiment, viewing interactive map user 56 may be denied an ability to zoom into and/or enter virtual office 26 by the interactive map 10, preventing a communications attempt by interactive map user 56 with entity 40.

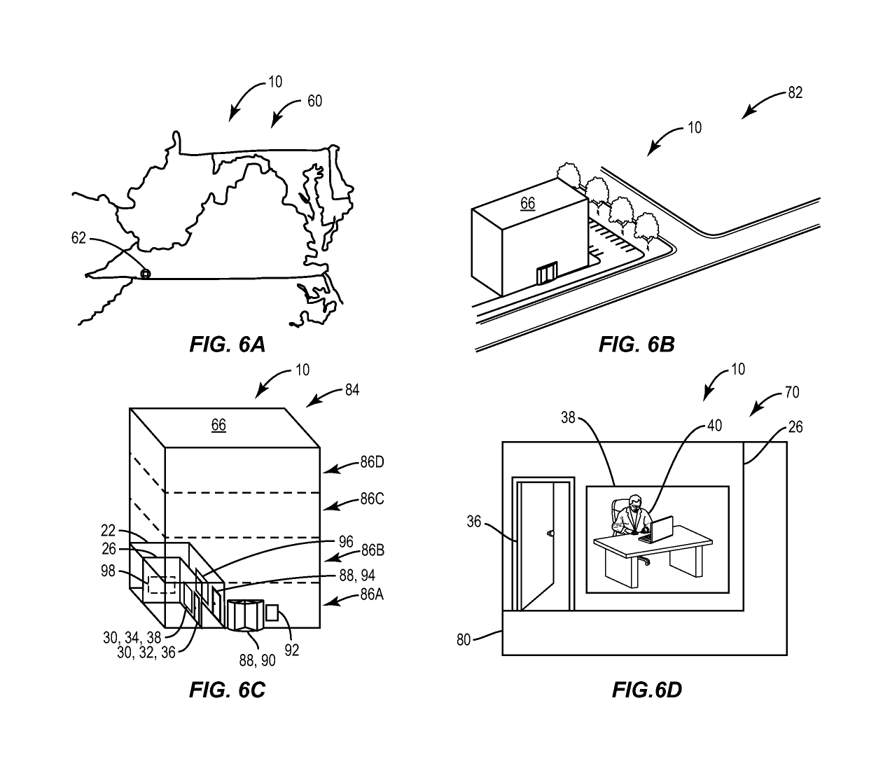

FIGS. 6A through 6D illustrate zooming in through various views of an interactive map 10 comprising availability metaphors 30 representing availability states of entities 40 for communications. FIG. 6A depicts an exemplary regional view 60 of the interactive map 10. An interactive map user 56 may provide a gesture to zoom into a zoom area 62 of the interactive map 10.

FIG. 6B depicts an exemplary aerial view 82 of the interactive map 10 which is exterior to a building 66. Aerial view 82 of the interactive map 10 may be viewed after zooming into (or successively zooming into) zoom area 62 of the interactive map 10. A gesture from interactive map user 56 may be received to request a three-dimensional model of the building 66. The received gesture may comprise swiping at least one finger up and then to the right ( [symbol] ) on the building 66 depicted in interactive map 10. The received gesture may comprise swiping one, two, three, or four fingers.

FIG. 6C depicts an exemplary three-dimensional building model view 84 of building 66 of interactive map 10. Three-dimensional building model view 84 may be displayed in response to receiving the above discussed gesture. Three-dimensional building model view 84 may be comprised of one or more building floors 86 (as non-limiting examples, 86A, 86B, 86C, 86D) of building 66. Each building floor 86A, 86B, 86C, 86D may comprise availability metaphors 30 (as non-limiting examples, presence metaphors 34 and/or interruptibility metaphors 32) for occupants of the building floors 86 and/or offices 26. A second gesture from interactive map user 56 may be received to enter the building model of the building 66 on a particular floor 86 (as a non-limiting example, 86A) among the one or more building floors 86. The second received gesture may comprise double-tapping at least one finger on the building model of building 66 at a location corresponding to the desired floor 86. The received gesture may comprise double-tapping one, two, three, or four fingers.

FIG. 6D depicts a three-dimensional building floor view 70 corresponding to the selected building floor 86. Three-dimensional building floor view 70 may be displayed in response to receiving the above discussed second gesture on the bottom most floor 86A displayed in FIG. 6C. Three-dimensional building floor views 70 corresponding to building floor layouts 86B, 86C, and/or 86D could have been alternatively displayed if the second gesture had been provided for those building floors 86.

Returning now to FIG. 6C, in addition to providing availability metaphors 30 (such as presence metaphors 34 and/or interruptibility metaphors 32), interactive map 10 may also provide one or more accessibility metaphors 88. An accessibility metaphor 88 indicates whether an interactive map user 56 viewing the interactive map 10 is permitted or forbidden to obtain information about building occupants (as non-limiting examples, occupants of a building, suite, or room). Accessibility state for an accessibility metaphor 88 may be provided by accessibility server 160 and/or accessibility rules database 162.

Virtual building entrance 90 may be provided as an accessibility metaphor 88. In one embodiment, virtual building entrance 90 may be provided as a spinning revolving door if the interactive map user 56 viewing the interactive map 10 is permitted to enter the building 66. Alternatively, virtual building entrance 90 may be provided as a stationary revolving door if the interactive map user 56 viewing the interactive map 10 is not permitted to enter (i.e., forbidden from entering) the building 66.

In another embodiment, virtual building entrance 90 may be provided as an open door if building 66 may be entered by viewing interactive map user 56. In this embodiment, virtual building entrance 90 may be provided as a closed door if the building 66 may not be entered by the viewing interactive map user 56.

In one embodiment, a viewing interactive map user 56 who was able to enter virtual building entrance 90 may view the state(s) of virtual door(s) 36 and/or virtual windows(s) 38 in building 66.

Map server 102 may provide additional functionality when one or more accessibility states are determined for parcels 50 of interactive map 10 based on the interactive map user 56 viewing interactive map 10. In this regard, method 200 may further comprise receiving an identity of a viewing interactive map user 56 for whom the map 10 is to be rendered. Method 200 may further comprise determining an accessibility state of a parcel 50 of the map 10 based on the identity of the viewing interactive map user 56. The parcel 50 of the map 10 may comprise the at least one availability metaphor 30 (as non-limiting examples, an interruptibility metaphor 32 and/or a presence metaphor 34). The accessibility state may represent whether or not the parcel 50 of the map 10 may be rendered for the viewing interactive map user 56. Method 200 may further comprise generating the modified instance of the map 10 based on the determined accessibility state to provide the at least one availability metaphor 30 for rending if the accessibility state indicates that the parcel 50 of the map 10 may be rendered for the viewing interactive map user 56. Method 200 may further comprise generating the modified instance of the map 10 based on the determined accessibility state to omit the at least one availability metaphor 30 from rendering if the accessibility state indicates that the parcel 50 of the map 10 may not be rendered for the viewing interactive map user 56.

Method 200 may further comprise determining the accessibility state of the parcel 50 of the map 10 based on at least one of the date and time at which the map 10 is rendered. Alternatively, method 200 may further comprise determining the accessibility state of the parcel 50 of the map 10 based on at least one of the date and time at which a request for the parcel 50 of the map 10 is received by map server 102. In this regard, a certain parcel 50 of the map may or may not be viewable by interactive map user 56 during business hours, after business hours, during weekdays, during weekends, and/or during holidays. Map server 102 may determine accessibility states of various parcels 50 of interactive map 10 based on accessibility rules provided from an accessibility rules server 160 and/or accessibility rules database 162 to map server 102. An accessibility state of a parcel 50 of interactive map 10 may also be determined based on calendar entries of a calendar (as a non-limiting example, from a calendar server 106) of entity 40.

Interactive map 10 may also comprise at least one accessibility metaphor 88 representing the accessibility state of the parcel 50 of the map 10 to the viewing interactive map user 56 viewing the map. An accessibility metaphor 88 may be provided at or proximate to an entrance to the parcel 50 of the map 10 to which accessibility metaphor 88 to represents accessibility.

Virtual building entrance interface 92 may provide an interface to allow an interactive map user 56 to enter credentials (as a non-limiting examples, a username and/or password) to access building 66.

Map server 102 (FIG. 7A) may determine the accessibility of a building 66 to the viewing interactive map user 56 based on one or more accessibility rules. In one embodiment, virtual building entrance 90 may be provided as open and available to the viewing interactive map user 56 if the viewing interactive map user 56 is an employee or authorized guest of a company having an office 26 in building 66. In another embodiment, virtual building entrance 90 may be provided as closed and unavailable for entering to the viewing interactive map user 56 during certain hours (as a non-limiting example, after business hours) and/or during certain days (as non-limiting examples, during weekends, and/or during holidays). In this regard, virtual building entrance 90 may be provided as closed and unavailable for entering to the viewing interactive map user 56 during a specific holiday (as a non-limiting example, during a Christmas break, such as from a Saturday on or before Christmas day of a year until the Sunday after Christmas day of that year). Virtual building entrance interface 92 may or may not allow an interactive map user 56 to enter credentials to access building 66 during the certain hours and/or certain days. As a non-limiting example, virtual building entrance interface 92 may or may not allow an interactive map user 56 to enter credentials to access building 66 during a specific holiday (as a non-limiting example, during the Christmas break), regardless of whether the interactive map user 56 is an employee or guest of the company having an office 26 in building 66.

A virtual suite entrance 94 may also be provided as an accessibility metaphor 88. In this regard, a viewing interactive map user 56 who was able to enter the building 66 may view the state of the virtual suite entrance 94. Virtual suite entrance 94 may be provided as an open door if viewing interactive map user 56 is permitted to enter the suite 22. Virtual suite entrance 94 may be provided as a closed door if the viewing interactive map user 56 is forbidden to enter the suite 22. In one embodiment, a viewing interactive map user 56 who was able to enter the virtual suite 22 may view the state of virtual door(s) 36 and/or virtual windows(s) 38 in the suite 22. Map server 102 may determine the accessibility of the virtual suite entrance 94 to the viewing interactive map user 56 based on one or more accessibility rules. In one embodiment, virtual suite door 96 may be provided as open and available to the viewing interactive map user 56 if the interactive map user 56 is an employee or authorized guest of a company occupying the suite 22.

Virtual suite interface 94 may provide an interface to allow an interactive map user 56 to enter credentials (as a non-limiting examples, a username and/or password) to access the suite 22.

An accessibility metaphor 88 is different from an availability metaphor 30. An accessibility metaphor 88 indicates whether a viewing interactive map user 56 is permitted to enter and/or view a certain parcel 50 of a building 66, whereas an availability metaphor 30 indicates whether an entity 40 (as non-limiting examples, a building occupant, suite occupant, or room occupant) is available to communicate with the viewing interactive map user 56.

A virtual whiteboard 98 may be provided in or outside a room or office 26. Virtual whiteboard 98 may represent a digital whiteboard in the real world. A viewing interactive map user 56 may write on or otherwise provide a message on virtual whiteboard 98 for communicating with the occupant (e.g., an entity 40) of a room or office 26.

Virtual doors (e.g., virtual building entrance 90, virtual suite door 94, and virtual room door 36) which act as availability metaphors 30, interruptibility metaphors 32, presence metaphors 34, and/or accessibility metaphors 88 may or may not appear to be a same type of door as a corresponding real world door of a corresponding real world building.

Interactive map 10 may provide a first user interface for navigating from an aerial view (as non-limiting examples, views 64, 82, 84) exterior to at least one building 66 to at least one interior building view of the at least one building 66. Interactive map 10 may provide a second user interface for navigating from the aerial view (as non-limiting examples, view 64, 82, 84) exterior the to at least one building 66 to a floor layout view (as non-limiting examples, views 12, 68) of the at least one building. Interactive map 10 may provide a third user interface for navigating from a street view (as non-limiting examples, views 64, 82, 84) exterior to the at least one building 66 to the at least one interior building view (as non-limiting examples, views 12, 68, 70) of the at least one building 66. Interactive map 10 may provide a fourth user interface for navigating from the street view (as non-limiting examples, views 64, 82, 84) exterior to the at least one building 66 to the floor layout view (as non-limiting examples, views 12, 68, 70) of the at least one building 66.

FIG. 7A is a block diagram illustrating an exemplary system 100 in which embodiments disclosed herein may be practiced. The system 100 includes a plurality of processing devices, such as a map server 102 and a plurality of map user devices 54A-54N (generally, map user devices 54 or user devices 54). The map user devices 54 are communicatively coupled to the map server 102 and to one another via one or more networks 112. System 100 may further include other processing devices, such as availability server 104, calendar server 106, entity device 108, and one or more entity sensors 110. Availability server 104, calendar server 106, entity device 108, and entity sensor(s) 110 are also communicatively coupled to the map server 102, map user devices 54, and to one another via the one or more networks 112. In one embodiment, entity sensors 110 may detect the presence or absence of an entity 40.

In one embodiment, map user device 54 is a device capable of receiving and rendering an interactive map 10 for an interactive map user 56 (as non-limiting examples, an interactive map user 56A, 56B, or 56C), as further described below. Map user device 54 may comprise, for example, a computer; a personal digital assistant (PDA); a Global Positioning System (GPS) device (as non-limiting examples, a handheld GPS device or vehicle GPS device), a mobile phone, such as an Apple® iPhone®, a Google® Android® phone, or the like, as non-limiting examples.

Map server 102 may be any type of map server. As non-limiting examples, map server 102 may comprise a Geographic Information Systems (GIS) server, a Google® Maps server, a Google® Earth server, a Microsoft® MapPoint Server, a Microsoft® Bing Maps Server, a Garmin® OpenStreetMap server, an Avaya® Web.alive® server and/or a Linden Research, Inc. SecondLife® server. Furthermore, map user device 54 may comprise any type of interactive map client. As non-limiting examples, map user device 54 may comprise a Geographic Information Systems (GIS) client, a Google® Maps client, a Google® Earth client, a Microsoft® MapPoint client, a Microsoft® Bing Maps client, a Garmin® OpenStreetMap client, an Avaya® Web.alive® client and/or a Linden Research, Inc. SecondLife® client. Map server 102 may also use any protocol and/or data structure for transmitting an interactive map 10 to a map user device 54.

While for purposes of illustration embodiments are described herein in the context of a single map user device 54, the embodiments are not limited to the use of a single processing device. One or more of the interactive map users 56 may participate in an interactive map 10 with multiple processing devices. Of course, the map user device 54 may also comprise a single processing device, such as a computer with a microphone and headset, or a smartphone, such that both the audio aspects and video aspects of the embodiments described herein are handled by a single processing device.

The map user devices 54 are communicatively coupled to map server 102 and to one another via one or more networks 112. While only a single network 112 is illustrated in FIG. 7A, it will be appreciated that communications may travel over multiple networks, such as a private local area network (LAN) in a participant's house, a public access network, an enterprise network, and so on, between the processing devices. The map user devices 54A-54D may connect to the network 112 via any suitable network access paths, such as, as non-limiting examples, telephony technology, digital subscriber line technology, cable modem technology, cellular technology, wireless broadband technology, Wi-Max®, Wi-Fi®, Bluetooth®, optical fiber networks, Ethernet, or the like. Data, such as control signals, audio signals, and the like, as non-limiting examples, are typically carried over a network access path connecting the map user device 54 to remaining portions of network 112.

An exemplary map user device 54, such as map user device 54A, includes a control system 114, which may include a processor 116 and a random access memory (RAM) 118, for controlling overall operation of the map user device 54A, and for rendering an interactive map 10 as discussed in greater detail herein.

Map user device 54 may also include a communications interface 120 that is adapted to communication with network 112 to facilitate communications between the map user device 54A and external devices, such as map server 102. The map user device 54 also includes, or is coupled to, a display 122 upon which images of an interactive map 10 may be rendered, and via which, with the aid of an input devices such as a mouse, a keyboard, a touch screen interface, virtual reality gloves, or other input devices, it is possible to interact with the interactive map 10.

Map user device 54A also preferably includes a media processor, such as an audio processor 124, which may generate a media stream that includes voice signals of an interactive map user 56A and sends the media stream to map server 102 continuously during an interactive map session, or continuously for as long as the map user device 54A detects that the interactive map user 56A is speaking. The media stream is typically, although not necessarily, a digitized data stream that is generated by audio processor 124 and represents the voice signals of interactive map user 56A. Over the course of an interactive map session, the media stream of any particular interactive map user 56 may be discontinuous, in that the media stream may be generated only when the interactive map user 56 is actually speaking. As used herein, the phrase “incoming media stream” will refer to a media stream that is sent from a map user device 54 to the map server 102, and the phrase “outgoing media stream” will refer to a media stream that is sent from the map server 102 to the map user device 54.

Audio processor 124 may also receive outgoing media streams from map server 102 and provide the outgoing media streams to an audio port 126 to which an audio device, such as a headset or speakers, may be coupled. Alternatively, if the map user device 54A is a handheld GPS device, vehicle GPS device, or smartphone, as non-limiting examples, the audio device may be integral with the map user device 54A.

Map user device 54 may also include an interactive map renderer 128 for rendering an interactive map 10. As a non-limiting example, the interactive map renderer 128 may render the interactive map 10 for display on display 122 of the map user device 54. Map user device 54 may also include an interactive map user interface 130 for allowing an associated interactive map user 56 to manipulate the interactive map 10.

Each map user device 54 establishes an interactive map session (or maps stream) with map server 102. The interactive map session (or maps stream) may comprise any type of session, connection, or stream between a respective map user device 54 and the map server 102 that enables the transmission of an interactive map 10 from the map server 102 to the respective map user device 54, irrespective of the underlying physical infrastructure used to carry the interactive map 10, or the particular protocol used to establish the communication session between the respective map user device 54 and the map server 102. As non-limiting examples, suitable protocols may include, for example, Transport Control Protocol (TCP), User Datagram Protocol (UDP), Internet Protocol (IP), and Hypertext Transport Protocol (HTTP), or the like. The embodiments disclosed herein may be provided as an extension of any protocol, signaling, or messaging that may be used for providing an interactive map 10 to a map user device 54. Map information may be streamed from map server 102 to a map user device 54A over the interactive map session (or maps stream). As used herein, the phrase “incoming maps stream” will refer to a maps stream that is sent from a map user device 54 to map server 102, and the phrase “outgoing maps stream” will refer to a maps stream that is sent from the map server 102 to the map user device 54.

An interactive map 10 of a map user device 54 may be a copy (as a non-limiting example, a synchronized copy) of an interactive map 10 of map server 102. Alternatively, the interactive map 10 of the map user device 54 may be generated based on the interactive map 10 of map server 102 but be different from the interactive map 10 of map server 102, for example, because the interactive map 10 of the map user device 54 may contain certain portions which are customized and/or specifically generated for the interactive map user 56, as a non-limiting example.

Map server 102 includes a communications interface 132 that is adapted to communicate with communication network 112, and can comprise any suitable combination of hardware and/or software necessary for sending an interactive map 10 to a map user device 54 and for receiving user interaction information or other input from an interactive map user 56 using an interactive map user interface 130 to interact with the interactive map 10.

Map server 102 also includes a control system 134, which may include a processor 136 and a memory 138, for controlling the overall operation of the map server 102. A voice recognition module 140 and/or phonetic processor 142 may enable one or more interactive map users 56 to issue voice commands through their map user device 54 during an interactive map session with the map server 102. Upon detecting a voice command or component portions of such a command, the voice recognition module 140 and/or phonetic processor 142 may provide the recognized command to the processor 136 of the map server 102 for further processing.

Map server 102 may maintain an interactive map 10 as a master interactive map 10. The master interactive map 10 may be modified to provide custom instances of the interactive map 10 for each map user device 54 (e.g., containing availability metaphors 30, as non-limiting examples, interruptibility metaphors 32 and/or presence metaphors 34 specific to each interactive map user 56). Map server 102 may serve at least some parcels 50 of the interactive map 10 to a map user device 54 as interactive map user 56 (associated with the map user device 54) enters and/or navigates to a region of the interactive map 10 corresponding to the at least some parcels 50 of the interactive map 10. The interactive map 10 provided to the map user device 54 may contain at least some parcels 50 which are common to all map user devices 54. The interactive map 10 provided to the map user device 54 may also contain at least some parcels 50 that are specific for a particular interactive map user 56.

An interactive map 10 may comprise at least one availability metaphor 30 for representing at least one availability state of at least one entity 40. As used herein, the term “metaphor” is defined as “an arrangement of virtual objects that represent an idea.” In this regard, an availability metaphor 30 provides an arrangement of virtual objects that represent the availability of an entity 40. As a non-limiting example, the availability metaphor 30 may comprise a visual metaphor for representing the availability of the entity 40. A “visual metaphor” is defined as “a visual arrangement of virtual objects that represent an idea.” Thus, a visual availability metaphor 30 provides a visual arrangement of virtual objects that represent the availability of an entity 40.

In one embodiment, map server 102 may determine the availability state of an entity 40 by transmitting a request for availability information for the entity 40 to an availability server 104. Availability server 104 may include a communications interface 144 that is adapted to communicate with network 112 to facilitate communications between the availability server 104 and the map server 102. Availability server 104 may also include a control system 146, which may include a processor 148 and a memory 150, for controlling overall operation of the availability server 104. Availability server 104 may also include a presence server 152 for serving presence information about entity 40. As used herein, the term “presence information” is defined as “information indicating whether an entity is present at a real world location or on a real world device.” Presence information about at least one entity 40 may be stored in a presence database 154 associated with the presence server 152. Though illustrated in FIG. 7A as integral to the availability server 104, presence database 154 may also be provided remotely to the availability server 104. In one embodiment, presence server 152 serves presence information to map server 102. In another embodiment, presence server 152 may serve presence information directly to one or more map user devices 54.

Availability server 104 may also include an interruptibility rules server 156 for serving interruptibility rules associated with at least one entity 40. As used herein, “interruptibility rules” are “rules for determining an interruptibility of an entity.” In one embodiment, an entity 40 may provide interruptibility rules for determining the interruptibility of the entity 40. Interruptibility rules for at least one entity 40 may be stored in at least one interruptibility rules database 158 associated with the interruptibility rules server 156. Though illustrated in FIG. 7A as integral to the availability server 104, interruptibility rules database 158 may also be provided remotely to the availability server 104.

Availability server 104 may also include an accessibility rules server 160 for serving accessibility rules for interactive map 10. As used herein, “accessibility rules” are “rules for determining accessibility of information within parcel(s) of an interactive map to an interactive map user.” In one embodiment, an entity 40 may provide accessibility rules for determining the accessibility of certain parcels 50 of interactive map 10 to an interactive map user 56. Those parcels 50 of interactive map 10 may or may not comprise availability metaphor(s) 30. Accessibility rules may be stored in at least one accessibility rules database 162 associated with the accessibility rules server 156. Though illustrated in FIG. 7A as integral to the availability server 104, accessibility rules database 162 may also be provided remotely to the availability server 104 and/or integral to map server 102.

System 100 may comprise additional devices for collecting and providing availability information to availability server 104. In one embodiment, system 100 comprises at least one calendar server 106. Calendar server 106 serves calendar information of at least one entity 40 to availability server 104. Any protocol for providing calendar information to the availability server 104 may be used. Exemplary protocols for providing calendar information include the Calendar Access Protocol (CAP) (for example, as defined in Request for Comments (RFC) 4324), iCalendar (for example as defined in Request For Comments (RFC) 5545), and their extensions, as non-limiting examples. Proprietary calendar protocols may also be used for providing calendar information to the availability server 104. Availability server 104 may use calendar information associated with an entity 40 provided from calendar server 106 to the availability server 104 to determine the interruptibility and/or presence of the entity 40.

Entity sensors 110 may sense sensory information about an entity 40 which may be used as inputs for determining an availability of the entity 40. In one embodiment, at least one entity sensor 110 detects information which may be processed by availability server 104 to determine the presence and/or interruptibility of an entity 40.

An entity device 108 may be used by an entity 40 to provide addressing and/or authorization information to availability server 104. Entity 40 may use entity device 108 to provide the addressing and/or authorization information to the availability server 104. As a non-limiting example, entity device 108 may provide addressing and/or authorization information to availability server 104 for accessing calendar information of the entity 40 from the calendar server 106. As a further non-limiting example, entity device 108 may provide addressing and/or authorization information to availability server 104 for accessing sensor information from one or more entity sensors 110.

Accessibility rules server 160 may also be used to permit and/or forbid a certain map user device 54 (or group of map user devices 54) from accessing sensor information from one or more entity sensors 110. In this regard, accessibility rules server 160 may permit a certain map user device 54 (or group of map user devices 54) to access information from certain entity sensors 110. Accessibility rules server 160 may forbid the certain map user device 54 (or group of map user devices 54) from accessing information from other entity sensors 110.

Referring now to FIG. 7B, entity sensors 110 may comprise any type of sensor for detecting sensory information which may be used to aid a determination of availability (e.g. a presence and/or interruptibility) of an entity 40. As depicted in FIG. 7B, non-limiting examples of entity sensors 110 include a camera 110A, a microphone 110B, a voice detector 110C, a phonetic processor 110D, a door sensor 110E, a seat sensor 110F, a computer activity sensor 110G, a keyboard activity sensor 110H, a mouse activity sensor 110I, a mobile phone location sensor 110J, a phone activity sensor 110K, a phone off-hook sensor 110L, an infrared sensor 110M, an ultrasonic sensor 110N, and a holstered device sensor 110P.

Further non-limiting examples of entity sensors 110 are now discussed. Camera 110A may be positioned to capture at least one image at or near a location that entity 40 may visit (such as a room or office 26 of the entity 40). Camera 110A may capture at least one still image and/or video. Using the at least one image from the camera 110A, availability server 104 may use motion detection algorithms, face recognition algorithms, and/or other instructions for determining the presence and/or interruptibility of the entity 40.

Microphone 110B may be positioned for capturing audio at or near a location that entity 40 may visit (such as a room or office 26 of the entity 40). Alternatively, microphone 110B may be positioned on or near a device that entity 40 may use. Availability server 104 may use voice detection, or phonetic processing to detect a voice, phonemes, or other sounds associated with an entity 40. Voice detector 110C and/or phonetic processor 110D may thus be used to aid in determining the presence and/or interruptibility of an entity 40, in this regard. At least one door sensor 110E may be used to detect whether at least one door is open or closed. As a non-limiting example, the at least one door sensor 110E may be used to detect whether an office door of the entity 40 or other room which may be habitually occupied by the entity 40 is open or closed.

Computer activity sensor 110G may provide information regarding whether a computer of an entity 40 is or is active or inactive. As a non-limiting example, computer activity sensor 110G may provide information regarding whether at least one office computer or phone of the entity 40 is in use. Keyboard activity sensor 110H may detect whether a keyboard of the entity 40 is in use. As a non-limiting example, keyboard activity sensor 110H may detect whether an office keyboard of the entity 40 is in use. Alternatively, keyboard activity sensor 110H may detect whether a PDA or smart phone of the entity 40 is in use. Mouse activity sensor 110I may detect whether a mouse of the entity 40 is in use. As a non-limiting example, mouse activity sensor 110I may detect whether an office mouse of the entity 40 is in use. Similar activity sensors may be provided for any other input device of the entity 40.

Mobile phone location sensor 110J may detect a location, velocity, and/or acceleration of a mobile phone of entity 40. A similar mobile location sensor may be provided for any other mobile possessions of the entity 40. As a non-limiting example, mobile location sensor 110J may be provided as a part of a key, keychain, and/or belt clip of the entity 40. Phone activity sensor 110K may detect the use of a phone of the entity 40. In one embodiment, the detection of usage of a phone of entity 40 may be used for determining that entity 40 is not interruptible (as a non-limiting example, because entity 40 is already speaking with someone else). Phone off-hook sensor 110L may also be used for detecting usage of the phone of entity 40. Infrared sensor 110M may be used for determining whether a room (e.g. an office 26) occupied by entity 40 is occupied (as a non-limiting example, by detecting a heat signature of an entity 40). Ultrasonic sensor 110N may be an ultrasonic motion sensor for detecting motion within an office 26 of entity 40.

Certain entity sensors 110 (as non-limiting examples, infrared sensor 110M and/or ultrasonic sensor 110N) may provide an entity 40 with an increased sense of privacy, as entity 40 may perceive such sensors to be less intrusive than a camera 110A. However, any of the herein described sensors may be used.

Holstered device sensor 110P may detect whether a device (as a non-limiting example, a mobile phone) of entity 40 is docked or holstered within a holster (as a non-limiting example, within a belt holster). Holstered device sensor 110P may be provided integral to a mobile phone of entity 40 and detect a magnet and/or radio frequency identification (RFID) tag provided integral to the holster. In one embodiment, detecting that the mobile phone of entity 40 is holstered may be interpreted as entity 40 being available (as a non-limiting example, interruptible). In a further embodiment, detecting that the mobile phone of entity 40 is not holstered may be interpreted to indicate that entity 40 is not available (as a non-limiting example, not interruptible).

One of skill in the art will appreciate other sensors that may be used in accordance with this disclosure to aid a determination of the availability (e.g., presence and/or interruptibility) of entity 40.

As may be appreciated by one of skill in the art from the disclosures provided herein, any of the servers, devices, or other components herein disclosed may be provided as a plurality of those servers, devices, or components. Providing the plurality of the servers, devices, or other components may increase the capacity and/or redundancy of those servers, devices, or other components. Certain non-limiting examples are now provided. Map server 102 may be provided as a plurality of map servers 102. Any one map user device 54A, 54B, and/or 54N may be provided as a plurality of map user devices 54A, 54B, and/or 54N. Availability server 104 may be provided as a plurality of availability servers 104. Calendar server 106 may be provided as a plurality of calendar servers 106. Entity device 108 may be provided as a plurality of entity devices 108. Each entity sensor 110 may be provided as a plurality of entity sensors 110. Presence server 152 may be provided as a plurality of presence servers 152. Interruptibility rules server 156 may be provided as a plurality of interruptibility rules servers 156. Accessibility rules server 160 may be provided as a plurality of accessibility rules servers 160.

Certain servers, devices, and/or other components herein disclosed may be provided in a different device illustrated in FIG. 7A. As a non-limiting example, map server 102 may comprise accessibility rules server 160 and/or accessibility rules database 162. As a further non-limiting example, map server 102 may comprise availability server 104. As a further non-limiting example, one or more map user device(s) 54 (as non-limiting examples, map user devices 54A, 54B, and/or 54N) may comprise map server 102. In one embodiment, each map user device 54 comprises a map server 102. Such map user devices 54 may be referred to as having preloaded maps.

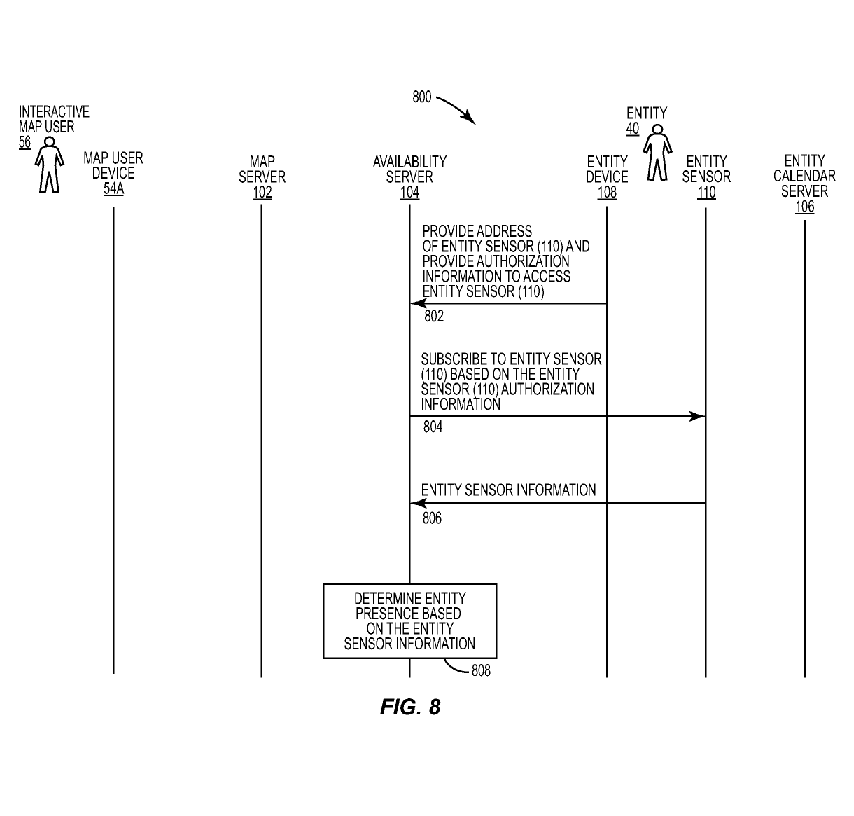

FIG. 8 illustrates an exemplary message flow 800 for determining an availability state (e.g., a presence state) of an entity 40. In this embodiment, an entity device 108 transmits an address of an entity sensor 110 along with authorization information for accessing the entity sensor 110 to availability server 104 (block 802). The entity device 108 may be associated with the entity 40. In one embodiment, entity 40 may provide the entity device 108 the address and/or authorization information for accessing entity sensor 110. Availability server 104 may positively acknowledge that transmission (not shown). Availability server 104 may thereafter subscribe to entity sensor 110 based on the provided address and/or authorization information for accessing entity sensor 110 (block 804). Entity sensor 110 may positively acknowledge the subscription (not shown). Thereafter, entity sensor 110 may provide at least one notification 806 comprising entity sensor information to availability server 104. In one embodiment, the notifications may be periodically sent to availability server 104. In another embodiment, the notification may be sent to availability server 104 when at least one detected event occurs. Availability server 104 may positively acknowledge the at least one notification (not shown). Availability server 104 may determine a presence of the entity 40 based on the provided entity sensor information (block 808).

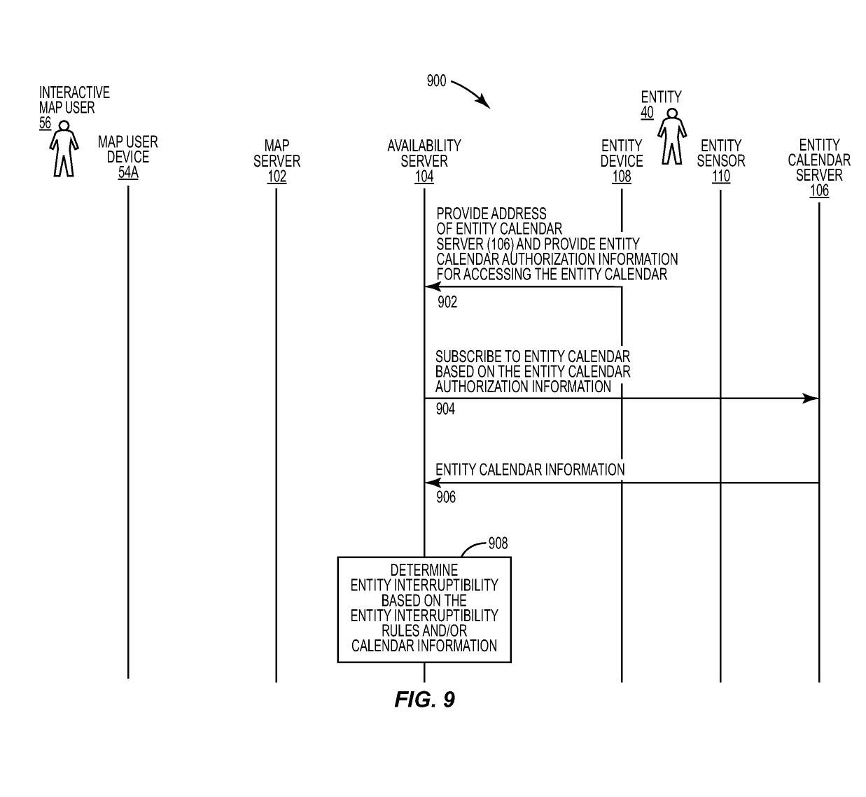

FIG. 9 illustrates an exemplary message flow 900 for determining an availability state (e.g., an interruptibility state) of an entity 40. In this embodiment, an entity device 108 transmits an address of an entity calendar server 106 along with authorization information for accessing calendar information of entity 40 to availability server 104 (block 902). The entity device 108 may be associated with the entity 40. In one embodiment, entity 40 may provide the entity device 108 the address and/or authorization information for accessing calendar information of entity 40. Availability server 104 may positively acknowledge the transmission (not shown). Availability server 104 may thereafter subscribe to real world calendar server 106 for entity calendar information of entity 40 based on the provided calendar server address of the calendar server 106 and/or authorization information for accessing the calendar information of entity 40 (block 904). Entity calendar server 106 may positively acknowledge the subscription (not shown). Thereafter, entity calendar server 106 may provide to availability server 104 at least one notification comprising calendar information for entity 40 (block 906). In one embodiment, a first notification 906 provides a complete listing of calendar information of entity 40. Thereafter, subsequent notifications 906 may be sent when calendar information of entity 40 is changed and/or updated. Availability server 104 may positively acknowledge the at least one notification (not shown). Availability server 104 may determine an interruptibility of entity 40 based on the provided calendar information for entity 40 and/or other interruptibility rules (block 908).

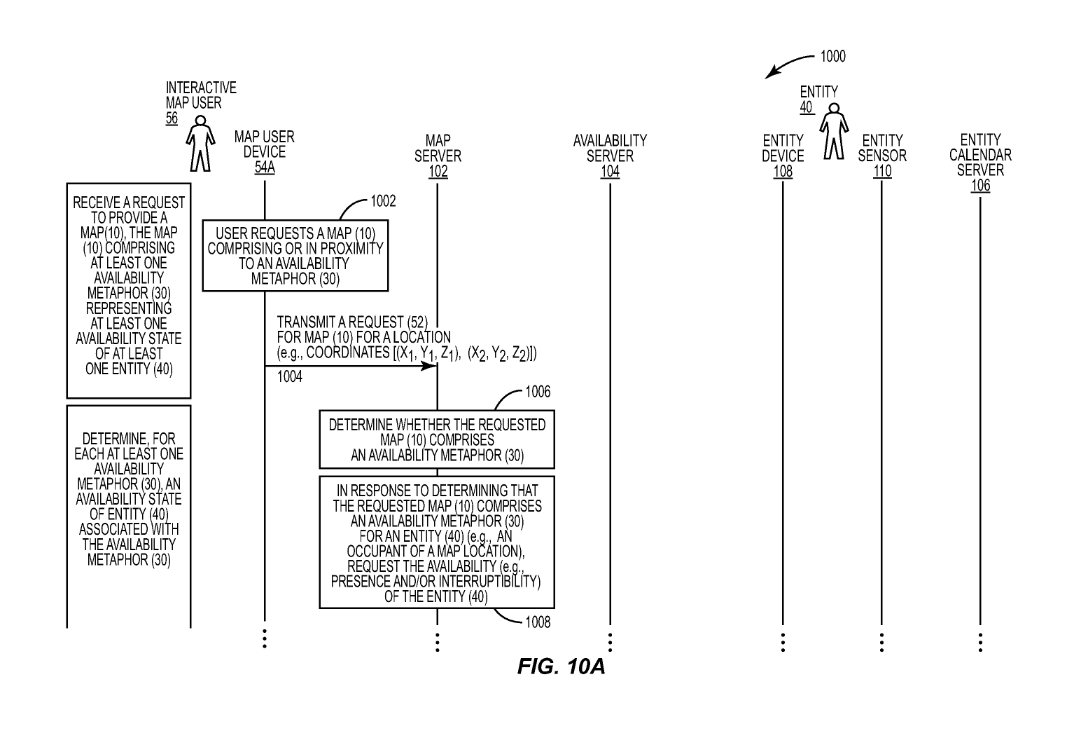

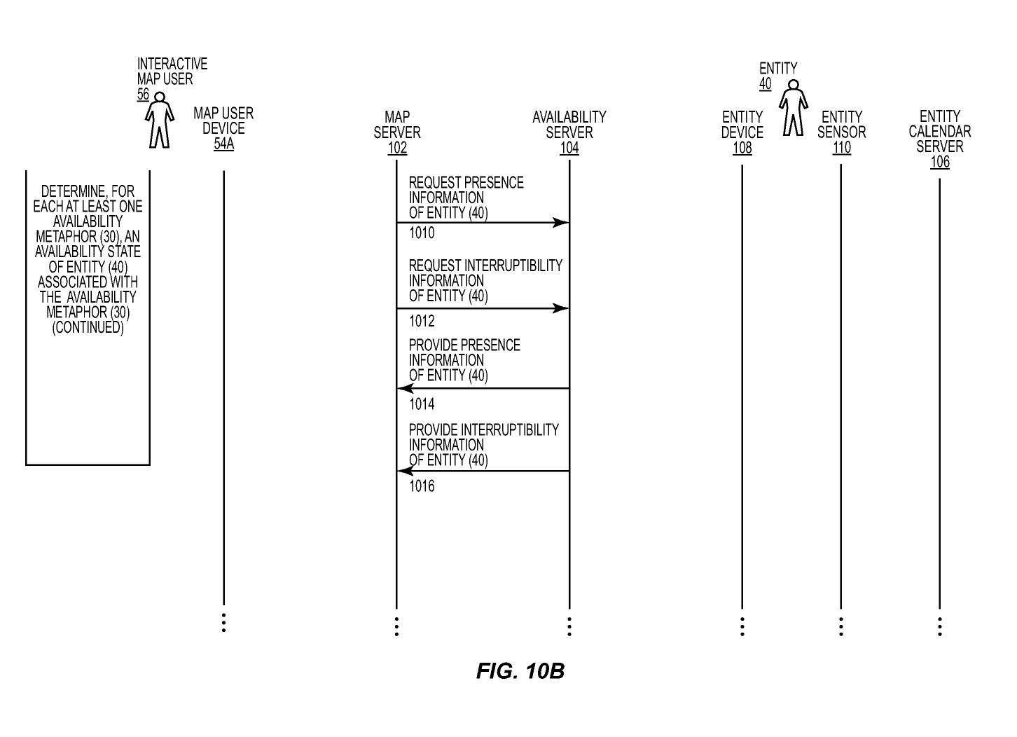

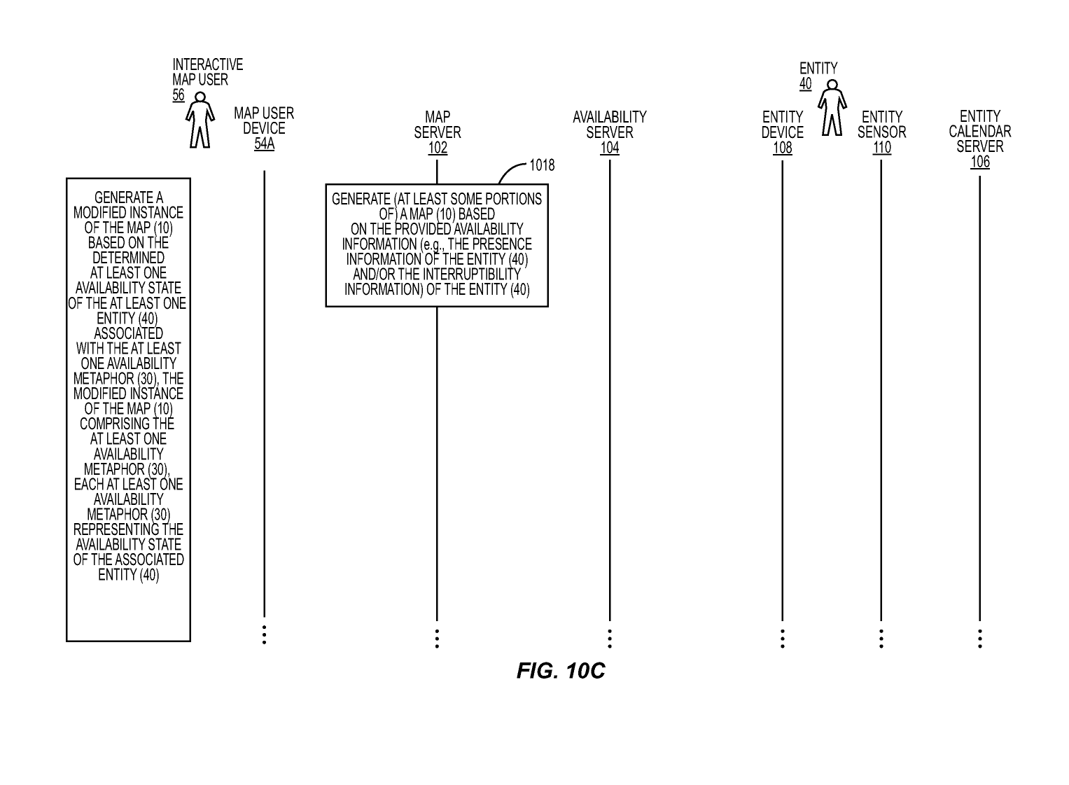

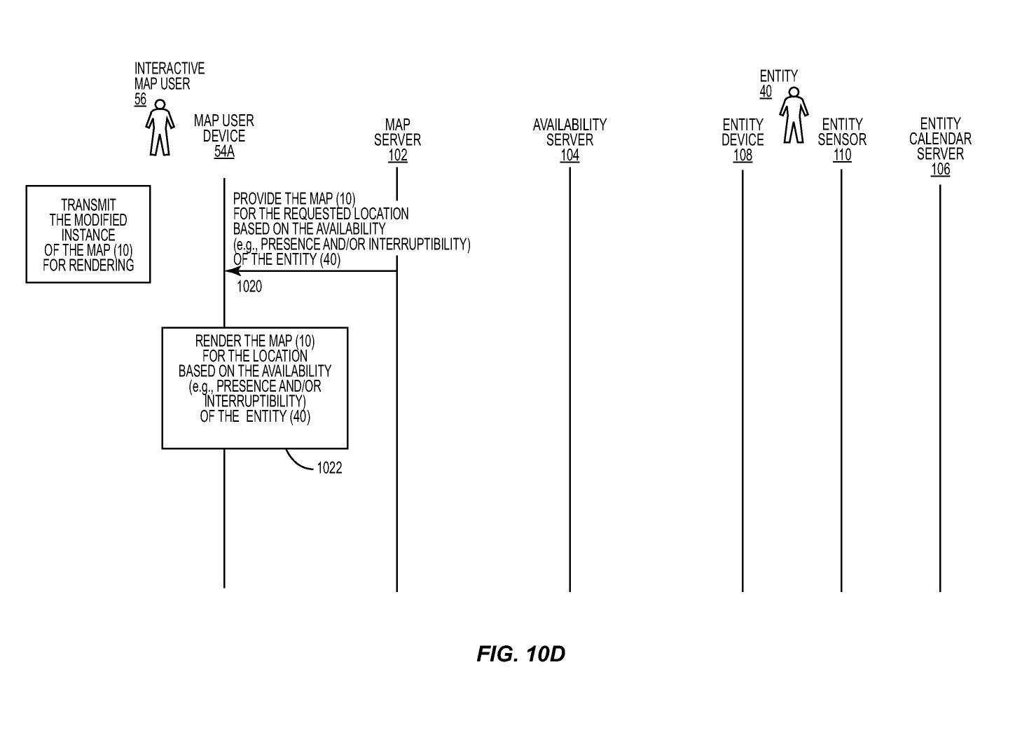

FIGS. 10A through 10D illustrate an exemplary message flow for providing at least one availability metaphor 30 of at least one entity 40 in an interactive map 10. In this embodiment, an interactive map user 56 uses a map user device 54A to view the proximity of an interactive map location comprising one or more availability metaphors 30 in the interactive map 10 (block 1002). As a result, map user device 54A transmits a request 52 to provide the interactive map 10, the interactive map 10 comprising at least one availability metaphor 30 representing at least one availability state of at least one entity 40. In one embodiment, map user device 54A may request an interactive map 10 for the newly proximate interactive map location in the interactive map 10, as a non-limiting example, by requesting coordinates of the newly proximate interactive map location (block 1004). Upon receiving the request 52, map server 102 may determine, for each at least one availability metaphor 30, an availability state of an entity 40 associated with the availability metaphor 30. Map server 102 may determine whether the requested interactive map 10 comprises an availability metaphor 30 (block 1006). In response to determining that the requested interactive map 10 comprises an availability metaphor 30 of an entity 40 of the interactive map location, map server 102 may request the availability (as non-limiting examples, presence and/or interruptibility) of the entity 40 (block 1008). In this regard, as a non-limiting example, map server 102 may request presence information of entity 40 from availability server 104 (block 1010). By way of a further non-limiting example, map server 102 may request interruptibility information of entity 40 from availability server 104 (block 1012).

Availability server 104 may provide presence information of entity 40 to the map server 102 (block 1014). Availability server 104 may also provide interruptibility information of entity 40 to the map server 102 (block 1016). Map server 102 may generate a modified instance of an interactive map 10 based on the determined at least one availability state of at least one entity 40 associated with the at least one availability metaphor 30. The modified interactive map instance (e.g. interactive map 10) may comprise the at least one availability metaphor 30. Each at least one availability metaphor 30 of the modified interactive map instance (e.g., interactive map 10) may represent the availability state of the associated entity 40. Accordingly, map server 102 may generate (at least some portions of) an interactive map 10 for map user device 54A (from an interactive map 10 on map server 102) based on the provided availability information (block 1018). The provided availability information may comprise the presence information of entity 40 and/or interruptibility information of entity 40. Thereafter, map server 102 may transmit the modified interactive map instance (e.g., interactive map 10) for rendering. In this regard, map server 102 may provide interactive map 10 for the requested interactive map location in the interactive map 10 based on the availability of the entity 40 (block 1020). The availability information may comprise presence information of entity 40 and/or interruptibility information of entity 40. Thereafter, map user device 54A may render the interactive map 10 for the requested interactive map location based on the availability of the entity 40 (for example, based on the presence and/or interruptibility of the entity 40, as non-limiting examples).

As depicted in FIGS. 10A through 10D, determining an availability state of an entity 40 may comprise transmitting a request for availability information for entity 40 to an availability server 104 (blocks 1010, 1012). As also depicted in FIGS. 10A through 10D, determining the availability state of entity 40 may comprise receiving the availability information for entity 40 from availability server 104 (blocks 1014, 1016). In one embodiment, the availability information for entity 40 received from availability server 104 may comprise availability rules for determining the availability state of entity 40. Alternatively, the availability information for entity 40 received from availability server 104 may comprise an availability state of entity 40 in the real world.

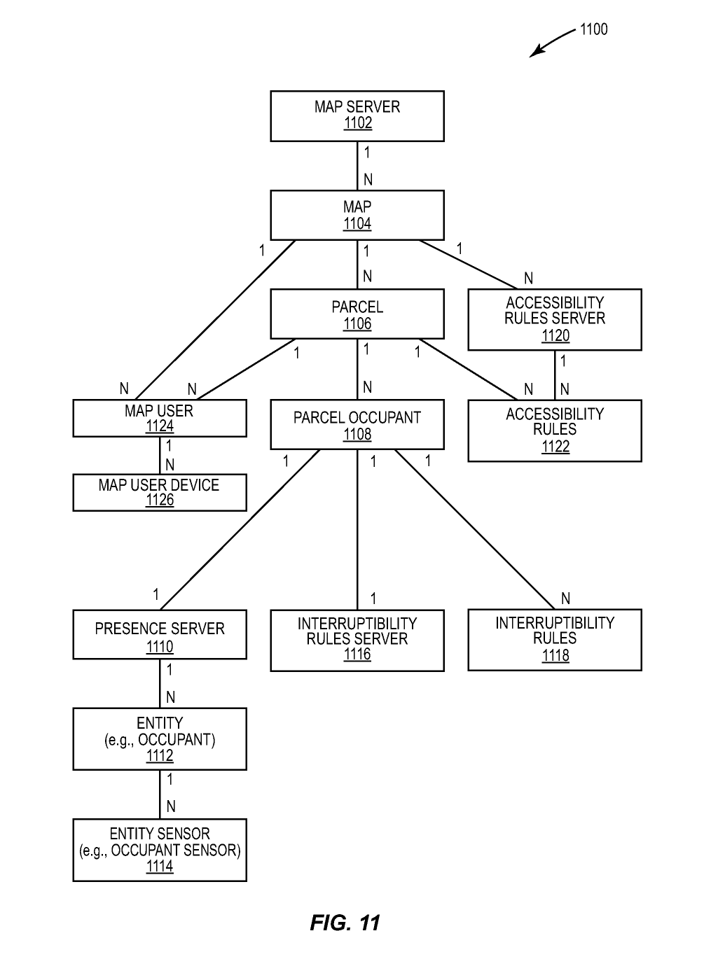

FIG. 11 illustrates an exemplary data structure 1100 for storage and retrieval of data for a map server 102. The data structure 1100 may or may not also be provided for an interactive map user device 54. The data structure 1100 comprises a map server record 1102 which may comprise information about the map server 102, including the network address of the map server 102. At least one interactive map record 1104 may be associated with the map server record 1102. At least one parcel record 1106 may be associated with each interactive map record 1104. Each parcel record 1106 may comprise information about an interactive map parcel. As non-limiting examples, the parcel record 1106 may provide information about the dimensions and location of the interactive map parcel in the interactive map 10. Parcel record 1106 may also comprise a list of availability metaphors 30 (for example, one or more presence metaphors 34 and/or one or more interruptibility metaphors 32, as non-limiting examples) which are located within the interactive map parcel associated with parcel record 1106. Each parcel record 1106 may also be associated with at least one parcel occupant record 1108. A parcel occupant record 1108 indicates occupant information about the interactive map parcel. As a non-limiting example, the parcel occupant record 1108 may comprise information about a real world occupant of a defined area in the real world represented by the parcel associated with the parcel record 1106.

Each parcel occupant record 1108 may be associated with a presence server record 1110 comprising information about the presence server 152 for the occupant associated with the parcel occupant record 1108. When an availability metaphor 30 of a parcel 50 corresponding to a parcel record 1106 needs to be populated with availability information, information in the parcel occupant record 1108 and presence server record 1110 may be used to contact a presence server record 1110 to receive the desired availability information for a parcel occupant associated with the parcel occupant record 1108. Presence server record 1110 may comprise addressing information and/or authorization information to obtain availability information about the parcel occupant from the presence server 152.

A presence server record 1110 may be associated with at least one entity record 1112. Entity record 1112 comprises information about an entity 40 for whom presence information is maintained on the presence server 152 associated with presence server record 1110. The entity 40 associated with entity record 1112 may or may not be an occupant. As a non-limiting example, entity 40 may be present on a device (as non-limiting examples, logged into a device, or detected using the device), but may or may not be associated with a defined area in the real world where presence information is tracked.

Each entity record 1112 may be associated with at least one entity sensor 1114 for sensing the presence and/or interruptibility of a corresponding entity 40. In one embodiment, an entity sensor 110 may be an occupant sensor for sensing whether the entity 40 is present at a defined area in the real world.

Parcel occupant record 1108 may also be associated with an interruptibility rules server record 1116. The interruptibility rules server record 1116 may contain addressing and/or authorization information for obtaining interruptibility rules from an interruptibility server.

Parcel occupant record 1108 may also be associated with at least one interruptibility rules record 1118. Each interruptibility rules record 1118 may comprise interruptibility rules for determining the availability of a parcel occupant associated with the parcel occupant record 1108. The interruptibility rules may be based on entity sensor information associated with entity sensor record 1114 or other information such as calendar information of the parcel occupant associated with the parcel occupant record 1108.

Map record 1104 may be associated with at least one map user record 1124 representing at least one interactive map user 56 viewing the interactive map 10. Parcel record 1106 may also each be associated with at least one map user record 1124 representing at least one interactive map user 56 viewing the interactive map 10. Each map user record 1124 may be associated with one or more map user device record(s) 1126 indicating the map user device(s) 54 that an interactive map user 56 is using to view interactive map 10.

Map record 1104 may also be associated with at least one accessibility rules server record 1120 indicating accessibility rules server(s) 160 providing accessibility rules for determining whether a map user 56 and/or map user device 54 may access a certain parcel 50 of interactive map 10. Accordingly, as depicted in FIG. 11, accessibility rules (associated with accessibility rules record 1122) may be provided on a per-parcel 50 basis. As such, a first parcel 50 associated with a first parcel record 1106 may have a different set of accessibility rules than a second parcel 50 associated with a second parcel record 1106.

In accordance with this disclosure, an interactive map 10 may represent real world locations in the real world. As non-limiting examples, such represented locations may comprise a room, an office, an office suite, a conference room, a vehicle, a lobby of a building, a building, and/or other volumes or enclosed spaces in the real world.

In accordance with this disclosure, an interactive map 10 may be augmented so as to provide availability metaphors 30 at certain locations within the interactive map 10. As a non-limiting example, virtual doors 36 may be provided at the depicted location of real world doors to provide availability metaphors 30 at those locations of the interactive map 10. As a further non-limiting example, virtual windows 38 may be provided at the depicted location of real world windows to provide availability metaphors 30 at those locations of the interactive map 10. Alternatively, a virtual door 36 may be depicted in relation to a parcel 50, but at a location other than the location of a real world door of the parcel 50. Similarly, a virtual window 38 may also be depicted in relation to the parcel 50, but at a location other than the location of real world window of the parcel 50.

In certain embodiments, at least one image captured from a camera 110A (FIG. 7B) in the real world office of entity 40 for displaying in or through a virtual window 38 may be captured at 10 second intervals, 20 second intervals, 30 second intervals, 1 minute intervals, 2 minute intervals, or 5 minute intervals. Other time intervals may also be used. Providing such periodic still images may allow entity 40 to perceive a greater sense of privacy than providing camera video from the camera in or through the virtual window 38. This may allow certain embodiments disclosed herein to more easily achieve user acceptance from one or more entities 40. However, camera video of the entity 40 may also be provided in or through virtual window 38.

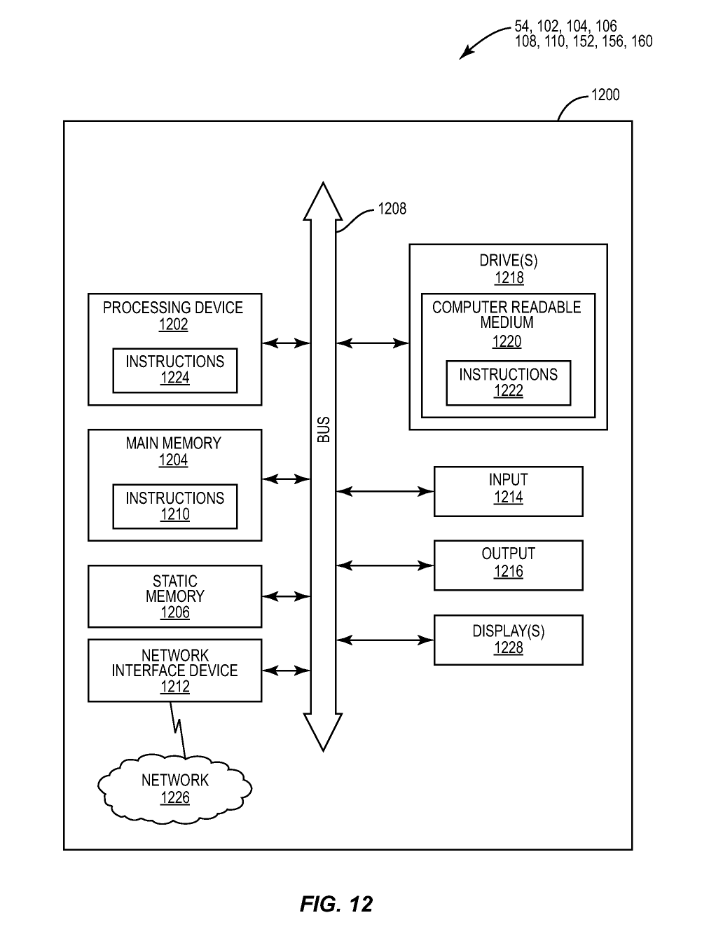

FIG. 12 provides a schematic diagram representation of map server 102 in the exemplary form of an exemplary computer system 1200 adapted to execute instructions from an exemplary computer-readable medium to perform the functions described herein. In this regard, the map server 102 may comprise the computer system 1200 within which a set of instructions for causing the map server 102 to perform any one or more of the methodologies discussed herein may be executed. The map server 102 may be connected (e.g., networked) to other machines in a local area network (LAN), an intranet, an extranet, or the Internet. The map server 102 may operate in a client-server network environment, or as a peer machine in a peer-to-peer (or distributed) network environment. While only a single map server 102 is illustrated, the terms “controller” and “server” shall also be taken to include any collection of machines that individually or jointly execute a set (or multiple sets) of instructions to perform any one or more of the methodologies discussed herein. The map server 102 may be a server, a personal computer, a desktop computer, a laptop computer, a personal digital assistant (PDA), a computing pad, a mobile device, or any other device and may represent, for example, a server or a user's computer, as non-limiting examples.

The exemplary computer system 1200 includes a processing device or processor 1202, a main memory 1204 (e.g., read-only memory (ROM), flash memory, dynamic random access memory (DRAM) such as synchronous DRAM (SDRAM), etc.), and a static memory 1206 (e.g., flash memory, static random access memory (SRAM), etc.), which may communicate with each other via a bus 1208. Alternatively, the processing device 1202 may be connected to the main memory 1204 and/or static memory 1206 directly or via some other connectivity means.

The processing device 1202 represents one or more processing devices such as a microprocessor, central processing unit, or the like. More particularly, the processing device 1202 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 1202 is configured to execute processing logic in instructions 1210 and/or cached instructions 1224 for performing the operations and steps discussed herein.

The computer system 1200 may further include a communications interface in the form of a network interface device 1212. It also may or may not include an input 1214 to receive input and selections to be communicated to the computer system 1200 when executing instructions. It also may or may not include an output 1216, including but not limited to display(s) 1228, a video display unit (e.g., a liquid crystal display (LCD) or a cathode ray tube (CRT)), an alphanumeric input device (e.g., a keyboard), a cursor control device (e.g., a mouse), a touch screen device (e.g., a tablet input device or screen), and/or at least one virtual reality glove.

The computer system 1200 may or may not include a data storage device that includes using drive(s) 1218 to store functions herein described in computer-readable medium 1220 on which is stored one or more sets of instructions 1222 (e.g., software) embodying any one or more of the methodologies or functions described herein. The functions can include method 200 and/or other functions of map server 102, as non-limiting examples. Instructions 1224 may also reside, completely or at least partially, within the main memory 1204 and/or within the processing device 1202 during execution thereof by the computer system 1200, the main memory 1204 and the processing device 1202 also constituting machine-accessible storage media. The instructions 1210, 1222, and/or 1224 may further be transmitted or received over a network 1226 via a network interface device 1212. The network 1226 can be an intra-network or an inter-network.

While the computer-readable medium 1220 is shown in an exemplary embodiment to be a single medium, the term “machine-accessible storage medium” should be taken to include a single medium or multiple media (e.g., a centralized or distributed database, and/or associated caches and servers) that store the one or more sets of instructions (as non-limiting examples, instructions 1210, 1222, and/or 1224). The term “machine-accessible storage medium” shall also be taken to include any medium that is capable of storing, encoding or carrying a set of instructions (as non-limiting examples, instructions 1210, 1222, and/or 1224) for execution by the machine and that cause the machine to perform any one or more of the methodologies of the embodiments disclosed herein. The term “machine-accessible storage medium” shall accordingly be taken to include, but not be limited to, solid-state memories, optical and magnetic media, and carrier wave signals.

As also depicted in FIG. 12, map user device 54, availability server 104, calendar server 106, entity device 108, and an entity sensor 110 may also each be provided in the form of an exemplary computer system 1200. In addition, presence server 152 and interruptibility rules server 156 may also each be provided in the form of an exemplary computer system 1200. Presence server 152 and interruptibility rules server 156 may also each be provided integral to availability server 104.

The devices, systems, methods, and computer-readable mediums providing availability metaphor(s) 30 representing communications availability of at least one entity 40 in an interactive map 10 according to embodiments disclosed herein may be provided in or integrated into any processor-based device. Examples, without limitation, include a set top box, an entertainment unit, a navigation device, a communications device, a fixed location data unit, a mobile location data unit, a mobile phone, a cellular phone, an internet phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

Those of skill in the art would further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The arbiters, master devices, and slave devices described herein may be employed in any circuit, hardware component, integrated circuit (IC), or IC chip, as non-limiting examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a processor, a digital signal processor (DSP), an Application Specific Integrated Circuit (ASIC), an field programmable gate array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, as non-limiting examples, in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A computer-implemented method of providing at least one availability metaphor representing communications availability of at least one entity in an interactive map, comprising:
receiving a request to provide a map, the map comprising at least one availability metaphor representing an availability state of an entity for communications;
determining, for the at least one availability metaphor, the availability state of the entity associated with the at least one availability metaphor;
generating a modified instance of the map based on the determined at least one availability state of the at least one entity associated with the at least one availability metaphor, the modified instance of the map comprising the at least one availability metaphor, the at least one availability metaphor representing the availability state of the associated entity; and
transmitting the modified instance of the map for rendering.

2. The method of claim 1, wherein the at least one availability state of the entity comprises an availability state of the entity for communications with a viewing entity viewing the map.

3. The method of claim 1, the method further comprising:
receiving a map gesture for initiating communications between the entity and the viewing entity; and
initiating communications among the entity and the viewing entity based on the received map gesture.

4. The method of claim 1, wherein the at least one availability metaphor of the entity comprises at least one availability metaphor of a person.

5. The method of claim 1, wherein the entity comprises an occupant of a defined area, and
wherein the map comprises at least one parcel representing the defined area.

6. The method of claim 5, wherein the defined area is at least one from the group consisting of: a volume, an enclosed space, a vehicle, a room, an office, an office suite, a conference room, a lobby of a building, and a building.

7. The method of claim 1, wherein determining the availability state of the entity comprises at least one of: determining a presence of the entity in a defined area, and determining a presence of the entity on a device.

8. The method of claim 1, wherein determining the availability state of the entity comprises determining an interruptibility of the entity.

9. The method of claim 8, wherein determining the interruptibility of the entity comprises determining the interruptibility of the entity based on at least one interruptibility rule.

10. The method of claim 1, wherein the at least one availability metaphor of the map comprises at least one image of a door representing an interruptibility of the entity.

11. The method of claim 1, wherein the availability metaphor of the map comprises at least one image of a window representing a presence of the entity.

12. The method of claim 1, further comprising rendering for display the modified instance of the map.

13. The method of claim 1, wherein the determining the availability state of the entity comprises:
transmitting a request for availability information for the entity to an availability server, and
receiving the availability information for the entity from the availability server.

14. The method of claim 13, wherein the availability information comprises at least one of: availability rules for determining the availability state of the entity, and the availability state of the entity.

15. The method of claim 1, further comprising:
receiving an identity of a viewing entity for whom the map is to be rendered; and
determining the availability of the entity based on the identity of the viewing entity.

16. The method of claim 15, further comprising:
receiving a second request to provide the map for a second viewing entity;
determining a second availability state of the entity based on the identity of the second viewing entity;
generating a second modified instance of the map based on the second availability state; and
transmitting the second modified instance of the map for rendering for the second viewing entity,
wherein the modified instance of the map and the second modified instance of the map are for concurrent rendering, and
wherein the modified instance of the map provides the entity as available and the second modified instance of the map provides the entity as not available.

17. The method of claim 1, wherein the interactive map provides at least one of the group consisting of:
a first user interface for navigating from an aerial view exterior to at least one building to at least one interior building view of the at least one building;
a second user interface for navigating from the aerial view exterior the to at least one building to a floor layout view of the at least one building;
a third user interface for navigating from a street view exterior to the at least one building to the at least one interior building view of the at least one building; and
a fourth user interface for navigating from the street view exterior to the at least one building to the floor layout view of the at least one building.

18. The method of claim 1, wherein the map is at least one of a two-dimensional map and a three-dimensional map.

19. The method of claim 1, the method further comprising:
receiving an identity of a viewing entity for whom the map is to be rendered;
determining an accessibility state of a parcel of the map based on the identity of the viewing entity, wherein the parcel of the map comprises the at least one availability metaphor, wherein the accessibility state represents whether or not the parcel of the map may be rendered for the viewing entity;
generating the modified instance of the map based on the determined accessibility state to provide the at least one availability metaphor for rending if the accessibility state indicates that the parcel of the map may be rendered for the viewing entity.

20. The method of claim 19, further comprising determining the accessibility state of the parcel of the map based on at least one of: a date on which the map is rendered, a time on which the map is rendered, and a calendar of the entity.

21. The method of claim 19, the map further comprising at least one accessibility metaphor representing the accessibility state of the parcel of the map to the viewing entity viewing the map.

22. An apparatus for providing at least one availability metaphor representing communications availability of at least one entity in an interactive map, comprising:
a communications interface adapted to interface with a network; and
a control system coupled to the communications interface and configured to:
receive a request to provide a map, the map comprising at least one availability metaphor representing an availability state of an entity for communications;
determine, for the at least one availability metaphor, the availability state of the entity associated with the at least one availability metaphor;
generate a modified instance of the map based on the determined at least one availability state of the at least one entity associated with the at least one availability metaphor, the modified instance of the map comprising the at least one availability metaphor, the at least one availability metaphor representing the availability state of the associated entity; and
transmit the modified instance of the map for rendering.

23. A computer-readable medium storing one or more programs, the one or more programs comprising instructions, which when executed by an electronic device cause the electronic device to implement a method for providing at least one availability metaphor representing communications availability of at least one entity in an interactive map, comprising:
receiving a request to provide a map, the map comprising at least one availability metaphor representing an availability state of an entity for communications;
determining, for the at least one availability metaphor, the availability state of the entity associated with the at least one availability metaphor;
generating a modified instance of the map based on the determined at least one availability state of the at least one entity associated with the at least one availability metaphor, the modified instance of the map comprising the at least one availability metaphor, the at least one availability metaphor representing the availability state of the associated entity; and
transmitting the modified instance of the map for rendering.
